(19) United States
(12) Patent Application Publication
(10) Pub. No.: US 2008/0154777 A1
(43) Pub. Date: Jun. 26, 2008

(54) Storage control device for protecting an electronic protection object with protection capability required by the protection object

(75) Inventor: Kyosuke Achiwa, Yamato (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/708,362

(22) Filed: Feb. 21, 2007

(30) Foreign Application Priority Data
Dec. 20, 2006 (JP) 2006-342279

(51) Int. Cl. G06Q 99/00

(52) U.S. Cl. 705/51; 711/114

(57) ABSTRACT

A storage control device is equipped with a protection controller, and storage device management information, which is information that includes a plurality of different protection capability values respectively associated with a plurality of storage devices having different protection capabilities, is stored in a storage resource of the storage control device. The protection controller uses the storage device management information stored in the storage resource to store an electronic protection object in one or more of the plurality of storage devices so as to satisfy a required protection capability value, which is the protection capability required by the protection object.

### CROSS-REFERENCE TO PRIOR APPLICATION

This application relates to and claims the benefit of priority from Japanese Patent Application number 2006-342279, filed on Dec. 20, 2006 the entire disclosure of which is incorporated herein by reference.

### BACKGROUND

The present invention relates to storage control for protecting an electronic protection object such as data.

The systems disclosed in U.S. patent application No. 2006/0031653 and Japanese Laid-Open Patent Application 2006-293864, for example, are know as storage systems equipped with a plurality of storage devices. U.S. patent application No. 2006/0031653 discloses a plurality of CAS (Content Addressable Storage) systems each having a virtual loop; this technology relates to I/O interruption to a virtual loop. Japanese Laid-Open Patent Application 2006-293864 discloses that data migration is performed within an alteration prevention period.

A RAIN (Redundant Array of Independent Nodes) type of storage system is also known, for example. This type of storage system (hereinafter referred to as a RAIN system) is made up of a plurality of nodes, and a disk-type storage device (such as a hard disk drive) is incorporated into each node. File level data (such as a file or directory) from a host respect to the nodes is stored in k-number of disk-type storage devices (hereinafter referred to as disk devices) incorporated into k-number of the plurality of nodes (where k is a constant value that is an integer greater than or equal to 2). In other words, the multiplicity of data is k. If a certain node should break down, the multiplicity of the data held by that node will drop under k, but with a RAIN system, data of decreased redundancy is copied from another node in which that data is stored to yet another node, and this restores the multiplicity of the data stored in the RAIN system to k.

With a RAIN system, the plurality of disk devices incorporated into the plurality of nodes are usually all the same type. The reason for this is that if the plurality of disk devices are of different types, then even though data is stored at a specific multiplicity n, the reliability of data protection may vary depending on which of the disk devices is used to store the data. To put this another way, one of the problems with a RAIN system is that if the plurality of disk devices are of different types, it will not necessarily be possible to protect data at the required protection capability.

### SUMMARY

Therefore, it is an object of the present invention to protect an electronic protection object at the protection capability required by this protection object, even if the plurality of storage devices comprised by the semiconductor have different protection capabilities.

Other objects of the present invention should be clear from the description that follows.

A storage control device is equipped with a protection controller, and storage device management information, which is information that includes a plurality of different protection capability values respectively associated with a plurality of storage devices having different protection capabilities, is stored in a storage resource of this storage control device. A protection controller uses the storage device management information stored in the storage resource to store an electronic protection object in one or more of the plurality of storage devices so as to satisfy a required protection capability value, which is the protection capability required by this protection object.

### BRIEF DESCRIPTION OF THE DRAWINGS

FIG. 1 illustrates an example of the structure of a computer system pertaining to a first embodiment of the present invention;

FIG. 2 is a diagram illustrating an example of the logical relationship between nodes and LDEVS;

FIG. 3 illustrates in simplified form an example of storage control performed by nodes;

FIG. 4A illustrates an example of the hardware structure of a management console;

FIG. 4B illustrates an example of the hardware structure of a storage sub-system 111;

FIG. 4C illustrates an example of the relationship between a RAID group and LDEVs;

FIG. 4D illustrates an example of the hardware structure of a node;

FIG. 5 illustrates the management software stored in the storage resource of a management console;

FIG. 6 illustrates the computer program and information stored in the storage resource of a node;

FIG. 7A illustrates an example of the structure of an LDEV management table;

FIG. 7B illustrates an example of the structure of a directory management table;

FIG. 8A illustrates an example of the structure of a file management table;

FIG. 8B illustrates an example of the structure of a file data management table;

FIG. 8C illustrates an example of the structure of an LDEV free block bitmap;

FIG. 9 illustrates an example of the flow of host write processing;

FIG. 10 illustrates an example of the flow of node write processing;

FIG. 11 illustrates an example of the flow of host read processing;

FIG. 12 illustrates an example of the flow of node read processing;

FIG. 13 illustrates an example of the flow of protect check processing;

FIG. 14 illustrates an example of the flow of setting an exclusion protect loop;

FIG. 15A illustrates an example of the flow of group production processing;

FIG. 15B illustrates an example of the flow of group deletion processing;

FIG. 16 illustrates an example of the flow of updating a protect point;

FIG. 17 illustrates an example of the flow of protect point update processing;

FIG. 18 illustrates an example of the flow of LDEV location processing;

FIG. 19 illustrates an example of the flow of LDEV validation;

FIG. 20 illustrates an example of the flow of LDEV validation processing;

FIG. 21 illustrates an example of the flow of LDEV invalidation;

FIG. 22 illustrates an example of the flow of LDEV invalidation processing;

FIG. 23 illustrates an example of the flow of updating a required protect point;

FIG. 24 illustrates an example of the flow of required protect point update processing;

FIG. 25 illustrates an example of the flow of processing for calculating free capacity;

FIG. 26A illustrates an example of a management menu screen;

FIG. 26B illustrates an example of an in-use LDEV information element list screen displayed in the flow of setting an exclusion protect group;

FIG. 26C illustrates an example of an in-use LDEV information element list screen displayed in the flow of updating a protect point;

FIG. 26D illustrates an example of an unused LDEV information element list screen displayed in the flow of LDEV validation;

FIG. 27A illustrates an example of an in-use LDEV information element list screen displayed in the flow of LDEV invalidation;

FIG. 27B illustrates an example of a screen displaying the structure of a directory or file;

FIG. 27C illustrates an example of a screen indicating that copying is in progress;

FIG. 27D illustrates an example of a screen indicating that copying has been completed;

FIG. 28 illustrates an example of the structure of a storage system in a second embodiment of the present invention;

FIG. 29A is a diagram illustrating an example of the method for setting the required protect point for a protection object;

FIG. 29B is a diagram illustrating an example of the method for controlling the required protect point of a file;

FIG. 30A is a diagram illustrating processing for determining whether to perform protect point processing or memory usage conservation processing in a third embodiment of the present invention;

FIG. 30B is a diagram illustrating memory usage conservation processing;

FIG. 31A is a graph showing that the required protect point of a directory is reflected in a file when no required protect point has been set to the file;

FIG. 31B is a graph showing that the required protect point of a file is maintained, regardless of the required protect point of a directory, when a required protect point has been set to the file; and

FIG. 32 is a diagram illustrating that the storage control of a protection object varies depending on whether redundancy or memory usage conservation is considered more important, in a fourth embodiment of the present invention.

### DESCRIPTION OF THE PREFERRED EMBODIMENTS

Several embodiments of the present invention will be described. An overview will be given prior to describing these several embodiments in detail.

The protection controller provided to a storage control device can be, for example, a processor that executes a host write processing program, a node write processing program, and a protect check processing program (all discussed below). The protection controller is such that a protection object A1 is stored in a plurality of storage devices corresponding to two or more protection capability values whose total is equal to or greater than the required protection capability value of the protection object A1. As a result, the protection object A1 is stored in one or more storage devices (multiplexed, for example).

The storage control device can further comprise a protection capability setting unit. This protection capability setting unit receives a designation of a storage device and a designation of a protection capability value associated with the storage device from an external console, which is a console outside of the storage control device, and includes a protection capability value associated with the storage device designated by the external console in the storage device management information. The external console can be a host, a management console, or the like.

The storage control device can further comprise a required protection capability value setting unit. This required protection capability value setting unit receives a designation of a protection object stored in at least one of the plurality of storage devices and a designation of the required protection capability value associated with the protection object from an external console, which is a console outside of the storage control device, and associates the designated required protection capability value with the protection object designated by the external console.

The protection controller determines whether or not there is a protection object whose required protection capability value has not been satisfied when either the required protection capability value of the protection object or the protection capability value of the storage device has been updated, and if a protection object whose required protection capability value has not been satisfied is detected, then the protection object A2 can be copied to a different storage device from the storage device in which the protection object A2 has been already stored so as to satisfy the protection capability value required by the protection object A2. Furthermore, the update here refers to a case in which the protection capability value of the storage device is set to zero. More specifically, the protection capability value of the storage device of a replace object is set to zero, for example. A protection capability value of zero may be set from an external console, or if a replace object (such as a storage sub-system or a RAID group) is designated from an external console, the storage device belonging to this replace object may be identified and the protection capability value of the identified storage device updated to zero. The protection controller can be such that when copying is completed for all of the protection objects whose required protection capability values have not been satisfied, information indicating the completion of copying can be sent to an external console. The external console can display the completion of copying.

More specifically, the required protection capability value of a protection object A2 can be maintained by replacing a storage device in the following flow, for example. The storage control device here is assumed to comprise a plurality of nodes.

A human connects a new storage device to a node A connected to an old storage device.

The human uses an external console to set the protection capability value of the old storage device to zero.

When this is done, the required protection capability value of the protection object A2 stored in the old storage device is no longer satisfied. Consequently, the node A performs self-healing processing. Specifically, the node A reads the protection object in the old storage device and copies it to a new storage device (or another node).

Once the self-healing processing is complete, the node for which this completion has been detected notifies the external console of completion, and the external console displays completion. This informs the human that the self-healing processing is finished. After this, the human removes the old storage device.

The above-mentioned storage device management information includes an information element that expresses which two or more of the plurality of storage devices constitute an exclusion group. The constitution can be such that the protection controller selects, as a copy destination for the protection object whose required protection capability value has not been satisfied, another storage device different from the storage devices in the exclusion group including the storage device storing the protection object, and copies the protection object to the other storage device thus selected.

The storage control device can further comprise an exclusion group production unit. The constitution can be such that this exclusion group production unit receives a designation of one or more of the plurality of storage devices and an exclusion group production designation from an external console, which is a console outside of the storage control device, and includes, in the storage device management information, an information element that expresses the exclusion group constituted by the one or more designated storage devices according to the group production designation from the external console.

The constitution can be such that each of the plurality of storage devices is a logical storage device provided on the basis of one or more physical storage devices. The constitution can be such that the exclusion group is a group constituted by a plurality of logical storage devices within a storage system equipped with a plurality of physical storage devices, or a group constituted by a plurality of logical storage devices provided by a RAID group. The RAID group is a group constituted by RAIDs, by means of two or more of the plurality of physical storage devices.

The constitution can be such that the protection object is a file and/or a directory, and the required protection capability value is associated with a file, a directory, or a group unit thereof. The constitution can be such that, when the protection controller receives a file sent from a host device and no required protection capability value is associated with the file, the required protection capability value of the directory of a write destination is associated with the file.

The constitution can be such that, in a first case, the protection controller stores the same protection object in plural storage devices, and in a second case, stores the same protection object in fewer storage devices than in the first case. For instance, the first case is when redundancy has greater importance than memory usage conservation, and the second case is when memory usage conservation has greater importance than redundancy.

The constitution can also be such that, when either the required protection capability value of the protection object or the protection capability value of the storage device has been updated, the protection controller deletes the protection object from at least one of the two or more storage devices in which the protection object is stored in a case where storage that satisfies the required protection capability value of the protection object can be maintained even if the protection object is deleted from the at least one storage device.

The constitution can be such that the storage control device is a storage system equipped with a plurality of nodes, or a plurality of nodes and a plurality of storage devices.

The various units mentioned above can be constructed from hardware, a computer program, or a combination of these (such as using a computer program for some and hardware for others). A computer program is executed after being read into a specific processor. In information processing in which a computer program is read into a processor, a storage area present in a memory or other such hardware resource may be used as needed. A computer program may also be installed in a computer from a CD-ROM or other such storage medium, or may be downloaded to the computer from a communications network. Also, a storage device may be either physical or logical. A physical storage device may be a magnetic disk, optical disk, magnetic tape, or semiconductor memory, for example. A logical storage device can be a logic volume.

Several embodiments of the present invention will now be described in detail through reference to the drawings.

### First Embodiment

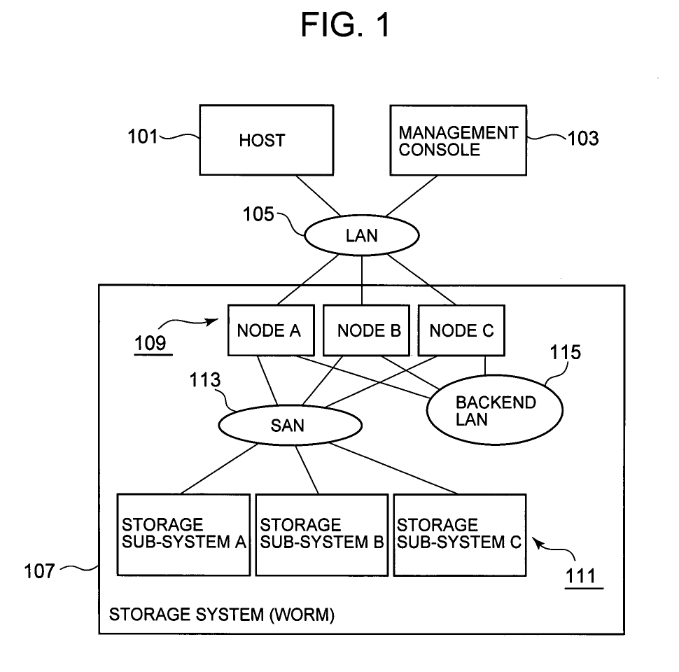

FIG. 1 illustrates an example of the structure of a computer system pertaining to a first embodiment of the present invention.

A host computer (hereinafter referred to simply as “host”) 101, a management console 103, and a storage system 107 are connected to a LAN (Local Area Network) 105. The storage system 107 is equipped with a plurality of nodes 109 and a plurality of storage sub-systems 111. The plurality of nodes 109 and the plurality of storage sub-systems 111 are connected to a SAN (Storage Area Network) 113. Also, the plurality of nodes 109 are each connected at their front end to the LAN 105, and are connected at their back end to another LAN 115. The LAN 115 will hereinafter being referred to as the “backend LAN 115” in order to differentiate it from the LAN 105.

The plurality of storage sub-systems 111 are each such that one or more logical storage devices (hereinafter referred to as “LDEV”) are provided to the plurality of nodes 109. An LDEV may also be called an LU (Logical Unit) or a logic volume. In this embodiment, all of the LDEVs of all of the storage sub-systems 111 can be seen (recognized) from all of the nodes 109, but this is not the only possibility, and which LDEV of which storage sub-system 111 is seen from which node 109 may also be limited.

The plurality of nodes 109 are each a computer, such as a personal computer. Each of the nodes 109 can communicate with other nodes 109 via the backend LAN 115. Also, every one of the nodes 109 can show the same file system to the host computer 101. Specifically, each of the nodes 109 can function as an NFS (Network File System) server with respect to the host computer 101, for example. In this case, the host 101 can function as an NFS client. It may also function as a CIFS (Common Interface File System) server or other type of file server instead of an NFS.

The host 101 requests the storage system 107 to write or read an electronic protection object (such as a file or directory). Specifically, for example, the host 101 sends a file level I/O request (write command or read command) to one of the plurality of nodes 109.

The management console 103 is a computer that manages the storage system 107. Specifically, for example, the management console 103 can gather and store information held by the nodes 109 via the LAN 105. Also, the management console 103 can set the retention period for a protection object going to a storage system 107 stored from the host 101. This prevents a protection object that has yet to reach its retention period from being overwritten or deleted by the host 101 or the storage system 107.

The above is an example of the structure of a computer system pertaining to this embodiment. In the above description, another type of communications network may be employed for one or more of the LAN 105, the backend LAN 115, and the SAN 113, for example. Also, for example, the backend LAN 115 and the SAN 113 may be a common communications network. Also, a single host 101 is shown in FIG. 1, but a plurality of hosts 101 may be used. Also, for example, the storage system 107 may be an archival storage system, or more specifically, it may be a WORM (Write Once, Read Many) type of storage system, for example.

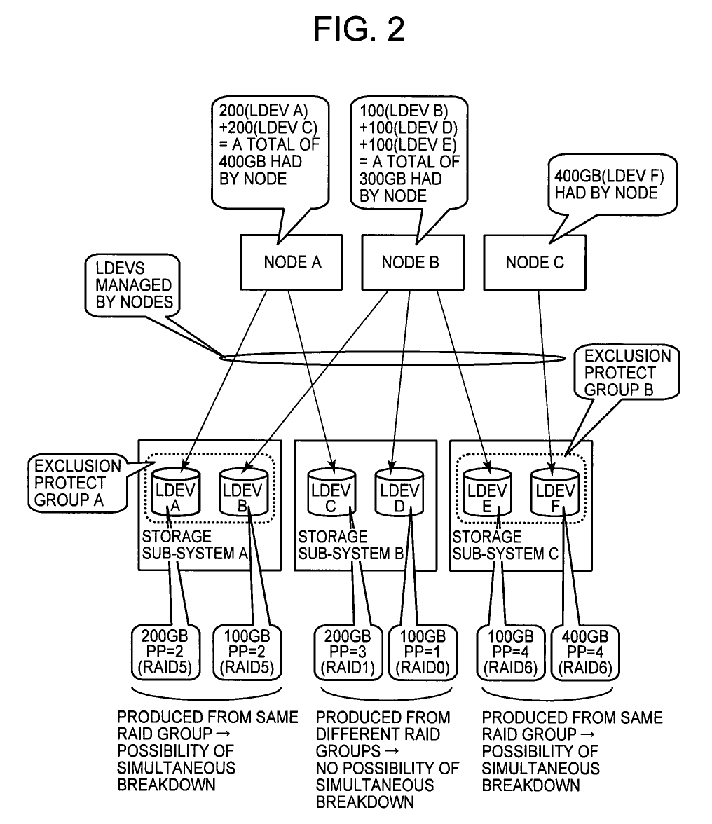

FIG. 2 is a diagram illustrating an example of the logical relationship between nodes and LDEVs.

Of the plurality of LDEVs in the plurality of storage systems, there are managed LDEVs and unmanaged LDEVs for the various nodes 109. In FIG. 2, the relationship between the nodes 109 and the LDEVs they manage is indicated by the solid-line arrows. The configuration will be described using node A as a typical example. Although a plurality of LDEVs A to F are seen, node A manages only LDEV A in storage sub-system A and LDEV C in storage sub-system B, and does not manage the other LDEVs B, D, E, and F. If the storage capacity for the LDEVs A and C is 200 GB (gigabytes) each, then node A has a total of 400 GB. When node A receives a file level I/O request from the host 101, if the LDEV that is the I/O destination according to this file level I/O request is its own management object (own node) (that is, if the LDEV is A or C), then a block level I/O request (such as a write or read command according to an SCSI (Small Computer System Interface)) is sent to this LDEV. On the other hand, if the LDEV that is the I/O destination according to this file level I/O request is not its own management object (that is, if the LDEV is B, for example), then the node A requests I/O to another node 109 (such as node B) for which this LDEV is a management object. In this case, this other node 109 issues a block level I/O request to that LDEV according to the request.

A protect point (abbreviated as PP in the drawings) is associated with each LDEV. The term “protect point” expresses the unlikelihood of losing data stored in an LDEV. Therefore, the higher is the protect point, the less likely it is that data will be lost. In this embodiment, the protect point associated with an LDEV is defined on the basis of what kind of RAID (Redundant Array of Independent (or Inexpensive) Disks) level RAID group that LDEV is associated with. More specifically, for example, a protect point “1” is associated with an LDEV provided to a disk device in which a RAID configuration is not employed, a protect point “2” is associated with an LDEV provided to a RAID group of RAID 5, a protect point “3” is associated with an LDEV provided to a RAID group of RAID 1, and a protect point “4” is associated with an LDEV provided to a RAID group of RAID 6. (The numbers in parentheses refer to the value as a protect point.) The protect point is determined, for example, by a manager using the management console 103. The protect point need not be an integer, and may be expressed as a decimal, a fraction, or the like. Also, the protect point of each LDEV may be determined automatically on the basis of storage device information by the host 101, the management console 103, or a node 109. The storage device information includes which LDEV is formed on the basis of a RAID group of which RAID level, and what type of storage devices make up the RAID group. In this case, the host 101, the management console 103, or a node 109 may determine the protect point of a LDEV on the basis of the RAID level of the RAID group to which the LDEV belongs and/or the type of storage device to which the LDEV belongs. Examples of types of storage device include disk-type storage devices (hard disk drives and DVDs (Digital Versatile Disk) drives) and flash memory devices. A disk-type storage device here may have an FC (Fiber Channel), SATA (Serial ATA), or the like.

Also, this embodiment involves the concept of an exclusion protect group. An “exclusion protect group” is a logical group of LDEVs for which there is the possibility of simultaneous breakdown (or, the possibility of simultaneous replacement). More specifically, for example, this is a group of a plurality of LDEVs formed the same RAID group. [The system] is controlled such that no data copying is performed between a plurality of LDEVs within an exclusion protect group (that is, within an exclusion protect group). More specifically, for example, [the system] is controlled such that no data is copied from an LDEV A within an exclusion protect group A to an LDEV B within the same exclusion protect group A.

With this embodiment, storing a protection object so as to satisfy the protect point required by the protection object (hereinafter referred to as the required protect point) is accomplished by the functions had by the nodes 109. A required protect point of a protection object (such as a file or directory) may be set with the host 101, or may be set from the management console 103.

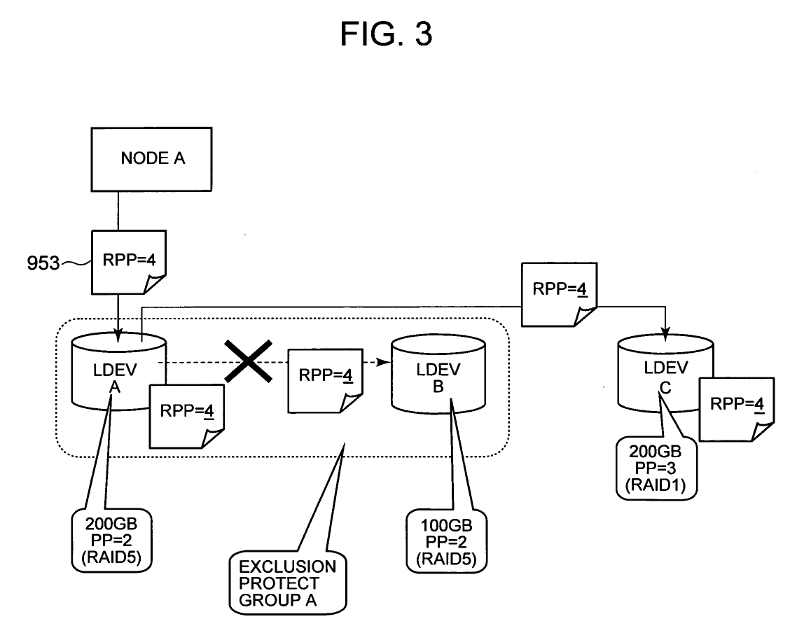

FIG. 3 illustrates in simplified form an example of storage control executed by the nodes 109.

For example, let us assume that a protection object 953 with a required protect point of “4” is written to an LDEV A with a protect point of “2” by the node A. This alone, however, will not result in storage that satisfies a required protect point of “4”. This is because the protect point “2” of the LDEV A that is the filing destination is less than the required protect point of “4”.

In view of this, node A copies the protection object 953 written to the LDEV A to another LDEV. If the sum of the protect point “2” of the LDEV A and the protect point of the LDEV that is the copying destination is at least the required protect point of “4” of the protection object 953, storage that satisfies the required protect point is considered complete. More specifically, for example, node A copies the protection object 953 from the LDEV A to the LDEV C, whose protect point is “3”. In this case, the sum of the protect points of the LDEV A and the LDEV C is “5”, and since this is greater than the required protect point of “4”, storage that satisfies the required protect point “4” is considered complete. Node A will not select as the copy destination the LDEV B in the exclusion protect group A to which the LDEV A belongs. This prevents the protection objects 953 from being simultaneously eliminated as a result of the simultaneously breakdown of the LDEVs A and B.

If the sum of the protect point “2” of the LDEV A and the protect point of the LDEV that is the copy destination is not at least the required protect point of “4”, then storage that satisfies the required protect point “4” is not complete, so the node A copies the protection object 953 to another LDEV. This processing is carried out until the sum of the protect point “2” of the LDEV A and the one or more protect points associated to the one or more LDEVs that are copy destinations is greater than or equal to the required protect point of “4”.

In other words, each of the nodes 109 executes storage control over a protection object whose required protect point is “n” such that the sum of the one or more protect points of the one or more LDEVs in which this protection object is stored is greater than or equal to the required protect point “n”.

This storage control is executed in one or more of the following cases: when the protect point of an LDEV has been updated, when the required protect point of a protection object has been updated, when LDEV validation processing has been executed, and when LDEV invalidation processing has been executed (each of these cases will be described in detail below). Here, when the LDEV that will be the write destination is not its own management object, the nodes 109 request the writing of a protection object to another node 109 in which the LDEV that will be the write destination is a management object. As discussed above, the nodes 109 each select an LDEV that does not belong to the exclusion protect group to which the LDEV that stores a protection object belongs, as the LDEV to which the protection object will be copied. Also, when the protection object written to a certain LDEV is copied to two or more other LDEVs, the nodes 109 each may copy that certain LDEV to two or more other LDEVs as common copy destinations (that is, so-called multi-target copying may be performed), or may copy it from a certain LDEV to a certain other LDEV, and copy it from the certain other LDEV to yet another LDEV (that is, so-called multi-hop copying may be performed).

This embodiment will now be described in detail.

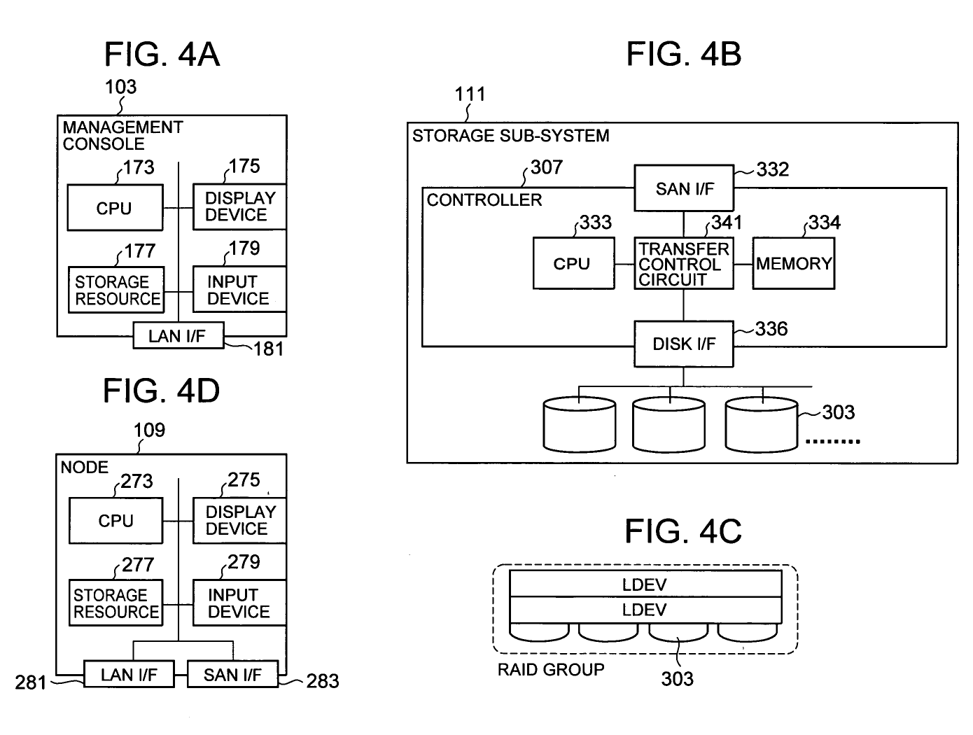

FIG. 4A illustrates an example of the hardware structure of the management console 103.

The management console 103 comprises a CPU 173, a storage resource 177, a display device 175, an input device 179, and a LAN I/F 181. The storage resource 177 can be constituted by a memory and/or a disk device, for example, but is not limited to this, and may be constituted by other types of storage medium. The LAN I/F 181 is an interface device for communicating via the LAN 105.

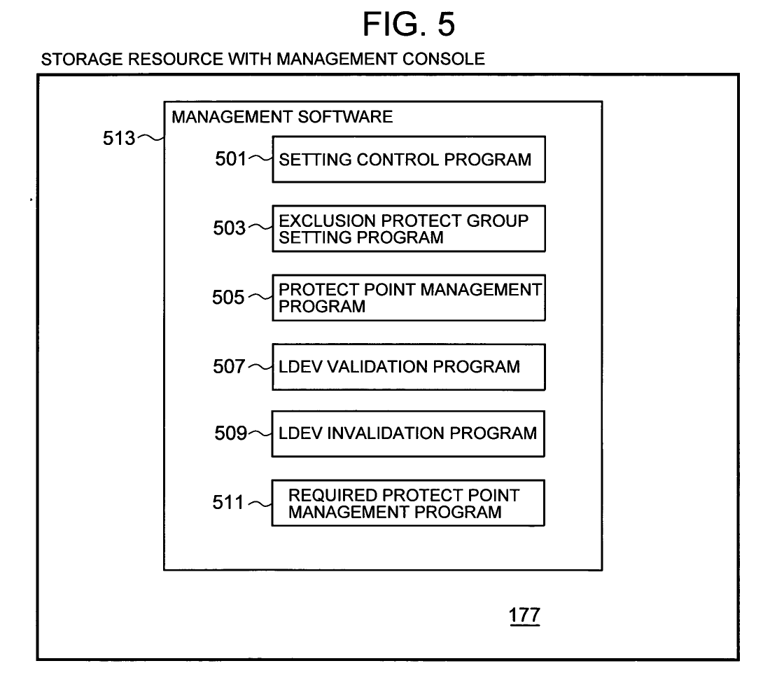

A plurality of computer programs executed by the CPU 173 are stored in the storage resource 177. More specifically, for example, as shown by the example in FIG. 5, management software 513 is stored in the storage resource 177. The management software 513 may be, for example, a setting control program 501, an exclusion protect group setting program 503, a protect point management program 505, an LDEV validation program 507, an LDEV invalidation program 509, and a required protect point management program 511. Each of these computer programs will be discussed below.

FIG. 4B illustrates an example of the hardware structure of a storage sub-system 111.

The storage sub-system 111 comprises a controller 307 and a plurality of disk devices 303. The controller 307 comprises, for example, a SAN I/F 332, a CPU 333, a memory 334, a disk I/F 336, and a transfer control circuit 341. The SAN I/F 332 is an interface device for executing communication via the SAN 113 (such as communication according to a fiber channel (FC) protocol). The memory 334 is utilized, for example, as a cache memory for temporarily storing block level data exchanged between the nodes 109 and the disk devices 303. The disk I/F 336 is an interface device for executing communication with the disk devices 303 (such as communication according to a FC protocol). The transfer control circuit 341 is an LSI (Large Scale Integration) chip for controlling connections between the SAN I/F 332, the CPU 333, the memory 334, and the disk I/F 336.

A RAID group can be constituted by two or more of the plurality of disk devices 303. A plurality of RAID groups are provided. As shown in the example in FIG. 4C, one or more LDEVs can be formed from a single RAID group by dividing up the storage space provided by the RAID group. Furthermore, one or more of the plurality of disk devices 303 may be another type of storage device, such as a flash memory device.

FIG. 4D illustrates an example of the hardware structure of a node 109.

The node 109 comprises a CPU 273, a storage resource 277, a display device 275, an input device 279, a LAN I/F 281, and a SAN I/F 283. The storage resource 277 can be constituted by a memory and/or a disk device, for example, but is not limited to this, and may be constituted by other types of storage medium. The LAN I/F 281 is an interface device for communicating via the LAN 105 and the backend LAN 115. The SAN I/F 283 is an interface device for executing communication via the SAN 113.

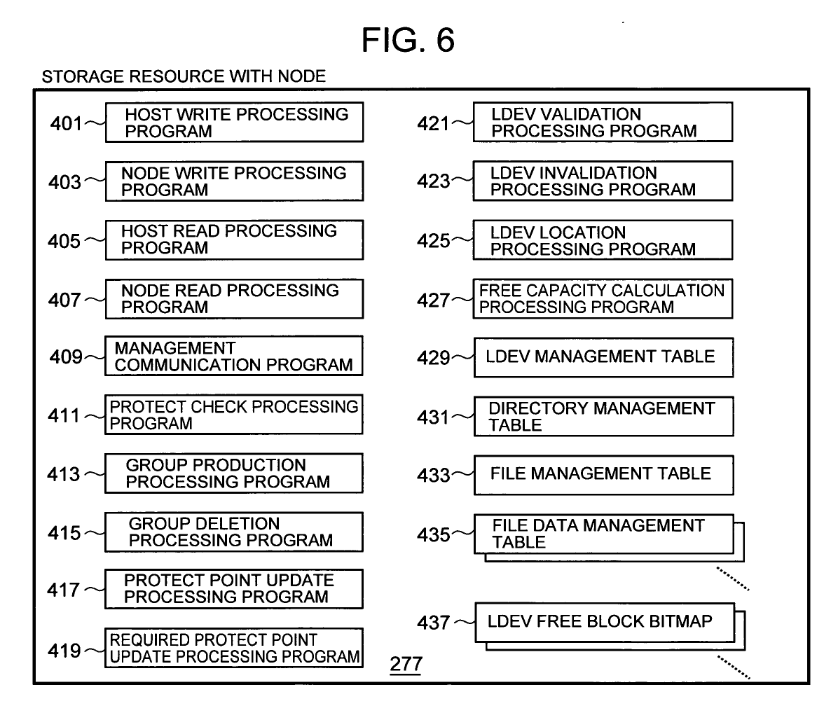

A plurality of computer programs executed by the CPU 273, or various kinds of information, are stored in the storage resource 277. As shown in the example in FIG. 6, these plurality of computer programs may include a host write processing program 401, a node write processing program 403, a host read processing program 405, a node read processing program 407, a management communication program 409, a protect check processing program 411, a group production processing program 413, a group deletion processing program 415, a protect point update processing program 417, a required protect point update processing program 419, an LDEV validation processing program 421, an LDEV invalidation processing program 423, an LDEV location processing program 425, and a free capacity calculation processing program 427, for example. Also, as shown in the example in FIG. 6, the various kinds of information may include an LDEV management table 429, a directory management table 431, a file management table 433, a file data management table 435, and an LDEV free block bitmap 437.

Various types of information will be described below. First, we will describe the LDEV management table 429.

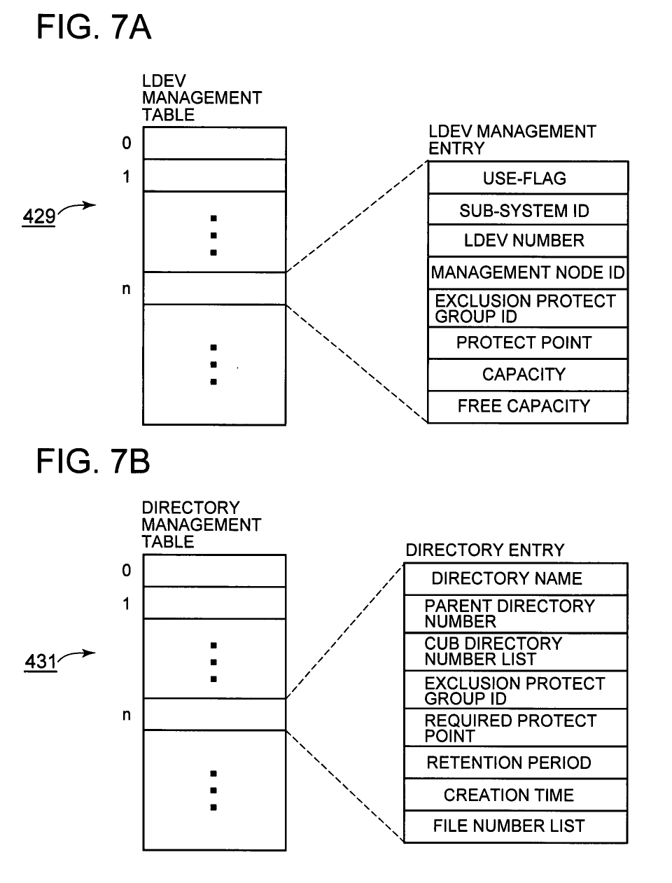

FIG. 7A illustrates an example of the structure of the LDEV management table 429.

The LDEV management table 429 is a table for managing the LDEVs in the storage system 107. All of the nodes 109 store LDEV management tables 429 of the same contents.

The various entry regions that make up the LDEV management table 429 correspond to a single LDEV and can be identified from the LDEV sequence number (in the drawings, 0, 1, . . . , n, . . . ). Each entry will hereinafter be called an LDEV management entry. The “LDEV sequence number” refers to the number of a unique LDEV in the storage system 107. The LDEV sequence number may be instead be called an LDEV management entry number.

Examples of the plurality of types of information element that can be registered in a single LDEV management entry include a use-flag, sub-system ID, LDEV number, management node ID, exclusion protect group ID, protect point, capacity, and free capacity. In the description of FIG. 7A that follows, an LDEV corresponding to a single LDEV management entry will be referred to as an “object LDEV”.

A use-flag represents the usage state of an object LDEV. More specifically, for example, a use-flag with a value of “1” means that the object LDEV is in use in the storage system 107 (a state in which I/O can occur in the object LDEV, for example). A use-flag with a value of “0” means that the object LDEV is not in use in the storage system 107 (a state in which I/O can not occur in the object LDEV, for example). A use-flag with a value of “−1” means that this LDEV management entry is invalid (a state in which three is not the object LDEV).

A sub-system ID is an identifier of the storage sub-system 111 having the object LDEV.

The LDEV number is the number of an LDEV that is managed within this storage sub-system 111 (the number of the object LDEV), and is different from the unique LDEV sequence number within the storage system 107.

The management node ID is an identifier of the node 109 whose management object is the object LDEV. If there is no node whose management object is the object LDEV, then a value that has that meaning (such as “−1”) is set as the management node ID. There is one management node for the object LDEV. This prevents the data in the object LDEV from being accidentally updated by another node. There may be a plurality of management nodes for a single object LDEV. The management node sends a specific reference command (such as an inquiry command supported by SCSI) to the object LDEV, which allows the sub-system ID and the LDEV number to be acquired from the storage sub-system 111 having the object LDEV.

The exclusion protect group ID is an identifier of the exclusion protect group of which the object LDEV is a constituent element. If there is no exclusion protect group of which the object LDEV is a constituent element (eg, if the object LDEV is the only unit where simultaneous malfunction occurs), a value having that meaning (“−1”) is set as the exclusion protect group ID.

The protect point is the protect point associated with the object LDEV. A protect point can be replaced or added for every LDEV, such as setting one for every storage sub-system, very RAID group, or every disk device. Regardless of by which unit it is set, however, the set protect point is reflected in the LDEV. More specifically, for example, when a certain protect point is set for a certain storage sub-system 111 or a certain RAID group, the designated protect point will be associated with all of the LDEVs in that storage sub-system 111, or with all of the LDEVs belonging to that RAID group.

The capacity is the storage capacity of the object LDEV.

The free capacity is the ratio (%) of the unused storage capacity, when the storage capacity of the object LDEV is 100%. The free capacity is calculated and set by the free capacity calculation processing discussed below.

The above is a description of the LDEV management table 429. Next, the directory management table 431 will be described.

FIG. 7B illustrates an example of the structure of the directory management table 431.

The directory management table 431 is a table for managing the directories in the storage system 107. All of the nodes 109 store directory management tables 431 of the same contents.

The plurality of entries that make up the directory management table 431 each correspond to a single directory, and can be identified from the directory sequence number (in the drawings, 0, 1, . . . , n, . . . ). Each entry will hereinafter be called a directory entry. The “directory sequence number” refers to the number of a unique directory in the storage system 107. The directory sequence number may be instead be called a directory entry number.

Examples of the plurality of types of information element that can be registered in a single directory entry include a directory name, a parent directory number, a cub directory number list, an exclusion protect group ID, a required protect point, a retention period, a creation time, and a file number list. In the description of FIG. 7B that follows, a directory corresponding to a single directory entry will be called an “object directory”.

A directory name is the title of an object directory. If this directory entry is invalid (a state in which no object directory is present), then a value indicating invalidity (such as “−1”) is set as the directory name.

A parent directory number is the directory sequence number of a parent directory for the object directory (the higher-level directory that is nearest to the object directory). If the object directory is a route directory, a value having that meaning (such as “−1”) is set as the parent directory number.

A cub directory number list is a list of the directory sequence numbers of all cub directories for the object directory (directories on a lower level than the object directory).

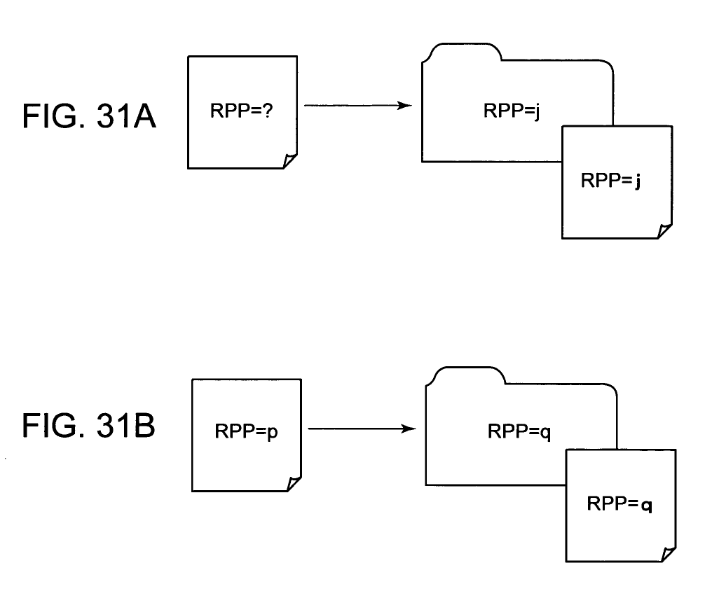

A required protect point is the required protect point associated with the object directory. This required protect point is the default value for the required protect points corresponding to files written in the object directory, or for the required protect points corresponding to cub directories of the object directory. That is, as shown in FIG. 31A, for example, if a file for which a required protect point has not been set is written to an object directory with a required protect point of “j”, the required protect point of the file is set to “j” (j≧0). Incidentally, as shown in FIG. 31B, for example, if a file with a required protect point of “p” is written to an object directory with a required protect point of “q”, the required protect point of the file will remain “p” (p≧0, q≧0). In other words, when a file for which a required protect point has not been set is written to a directory, the required protect point of the directory is associated with the file, and when a file for which a required protect point has been set is written to a directory, the required protect point of the file is preserved, regardless of the required protect point of the directory.

A retention period is the period over which an object directory is retained. For instance, when a node 109 that manages an object directory is requested by the host 101 to delete the object directory, if the time of the receipt of the request is not beyond the retention period, the object directory is not deleted, but if time of the receipt of the request is beyond the retention period, the object directory can be deleted according to the request. Furthermore, the retention period can also be associated with a file by being added to or updated for a directory, and the relationship between the retention period of a directory and the retention period of a file can be the same as the relationship between the required protect point of a directory and the required protect point of a file. More specifically, for example, when a retention period has been set for a directory, any files for which a retention period has not been set out of the plurality of files in the directory are assigned the retention period of the directory, and any files for which a retention period has been set may retain the retention period regardless of the retention period of the directory.

A creation time is the time when an object directory is created in the storage system 107.

A file number list is a list of file sequence numbers for zero or more files present in an object directory (the file sequence numbers will be discussed below).

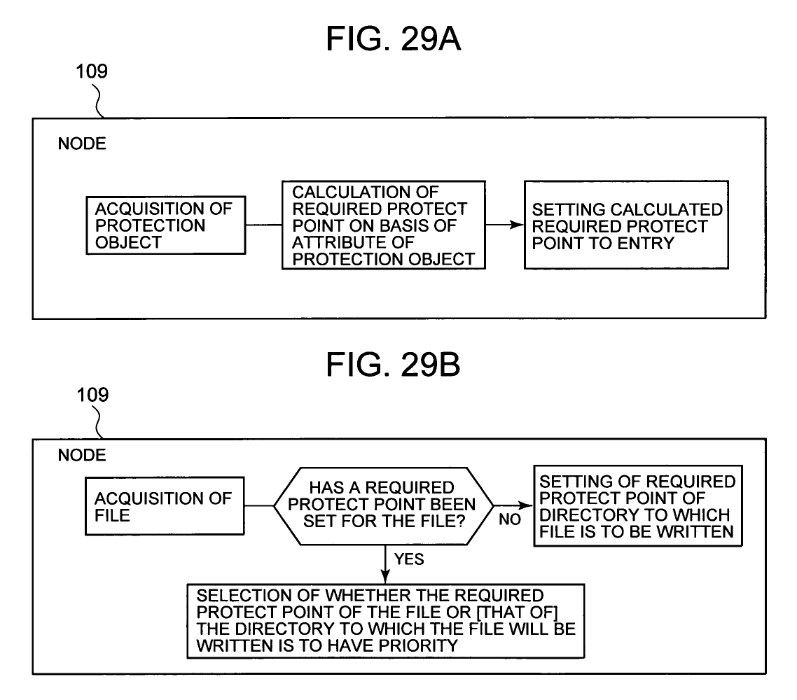

The above is a description of the directory management table 431. Further, as shown in FIG. 29A, for example, a required protect point associated with a file, a directory, or another such protection object may be automatically determined by a node 109 (such as the host write processing program 401) on the basis of the attribute of the protection object. Also, as shown in FIG. 29B, for example, when a required protect point is set for a file, whether the required protect point of the file or the required protect point of the directory where the file is to be written will have priority may be automatically selected by the node 109 (such as the host write processing program 401) by a specific method (such as on the basis of the attribute of a file or directory, or according to a preset mode). If the required protect point of the directory is given priority, the required protect point of the file is updated to the required protect point of the directory, and if the required protect point of the file is given priority, the required protect point of that file may be retained. The attribute of the protection object here is, for example, the type of protection object (such as a file or directory). Examples of file attributes that can be used include the name of the file, an identifier, and a retention period. Examples of directory attributes that can be used include the name of the directory, its creation time, and a retention period.

Next, the file management table 433 will be described.

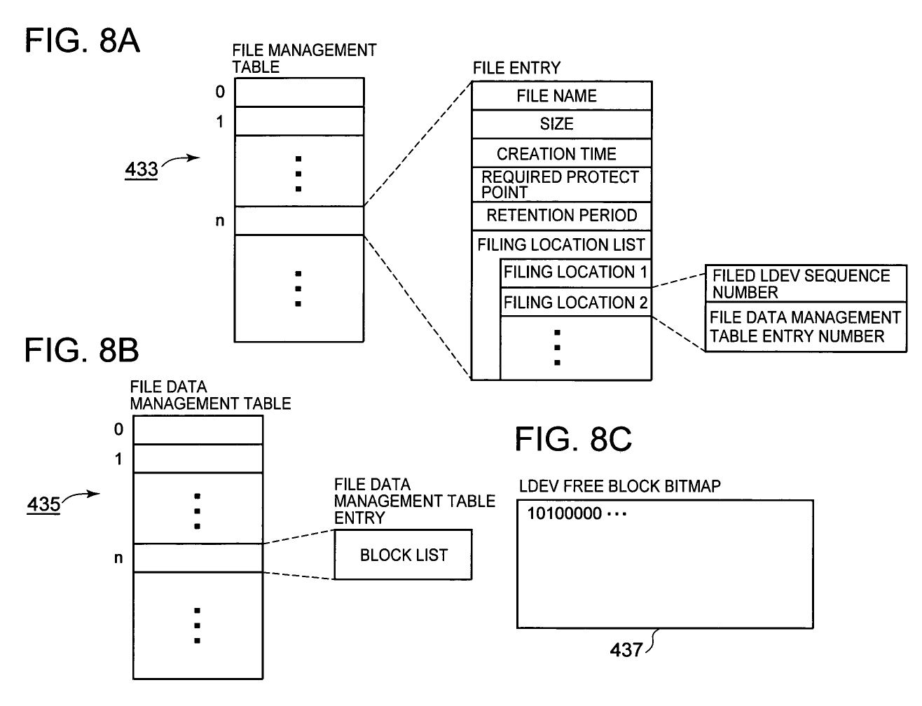

FIG. 8A illustrates an example of the structure of the file management table 433.

The file management table 433 is a table for managing the files in the storage system 107. All of the nodes 109 store file management tables 433 of the same contents.

The various entries that make up the file management table 433 correspond to a single file, and can be identified from the file sequence number (in the drawings, 0, 1, . . . , n, . . . ). Each entry will hereinafter be called a file entry. The “file sequence number” refers to the number of a unique file in the storage system 107. The file sequence number may be instead be called a file entry number.

Examples of the plurality of types of information element that can be registered in a single file entry include the file name, size, creation time, required protect point, retention period, and filing location list. In the description of FIG. 8A that follows, a file corresponding to a single file entry will be referred to as an “object file”.

The file name is the title of an object file. If this file entry is invalid (a state in which no object file is present and various information elements can be written), then a value indicating invalidity (such as “−1”) is set as the file name.

The size is the data size of an object file.

The creation time is the time an object file was created in the storage system 107 (such as the time it was written from the host, 101).

The required protect point is a required protect point associated with an object file.

The retention period is a retention period associated with an object file.

The filing location list is a list of the information at a plurality of locations at which a plurality of block data corresponding to an object file are present. More specifically, for example, a filing location list is made up of a plurality of sub-entries, and in these sub-entries are stored, for example, the stored LDEV sequence number and the file data management table entry number as information elements related to the locations where block data are stored. The stored LDEV sequence number is an LDEV sequence number corresponding to an LDEV in which block data is stored. If there is no such LDEV, an invalid value having that meaning (such as “−1”) is set as the stored LDEV sequence number. The “file data management table entry number” is the entry number of a file data management table corresponding to the LDEV.

The above is a description of the file management table 433. Next, the file data management table 435 will be described.

FIG. 8B illustrates an example of the structure of the file data management table 435.

The file data management table 435 is a table for managing where block data corresponding to a file will be stored in an object LDEV. A file data management table 435 is stored in every LDEV. That is, the “object LDEV” referred to in the description of FIG. 8B here means an LDEV corresponding to the file data management table 435. A file data management table 435 corresponding to an LDEV managed by a node 109 is stored in that node 109, and file data management tables 435 corresponding to LDEVs not managed by that node 109 are not stored.

The various entries that make up the file data management table 435 correspond to a single file, and can be identified from the file data management table entry number (in the drawings, 0, 1, . . . , n, . . . ). Where the block data of a file corresponding to a single file data management table entry (hereinafter referred to as an “object file”) is stored in the object LDEV is recorded in the entry. More specifically, for example, a list of the numbers of one or more blocks in which one or more block data corresponding to object files are stored (blocks that make up the object LDEV (logical storage region)) is recorded. This list will hereinafter be called a block list.

The above is a description of the file data management table 435. Next, the LDEV free block bitmap 437 will be described.

FIG. 8C illustrates an example of the structure of the LDEV free block bitmap 437.

The LDEV free block bitmap 437 is a table for managing which blocks in an object LDEV are free. A LDEV free block bitmap 437 is stored in every LDEV. That is, the “object LDEV” referred to in the description of FIG. 8C here means an LDEV corresponding to the LDEV free block bitmap 437. A LDEV free block bitmap 437 corresponding to an LDEV managed by a node 109 is stored in that node 109, and LDEV free block bitmaps 437 corresponding to LDEVs not managed by that node 109 are not stored. The bits that make up the LDEV free block bitmap 437 correspond to the plurality of blocks that make up the object LDEV. A value of “1” means that a block is free (a block in which no data is stored).

The above is a description of the LDEV free block bitmap 437.

The various kinds of processing carried out in this embodiment will now be described.

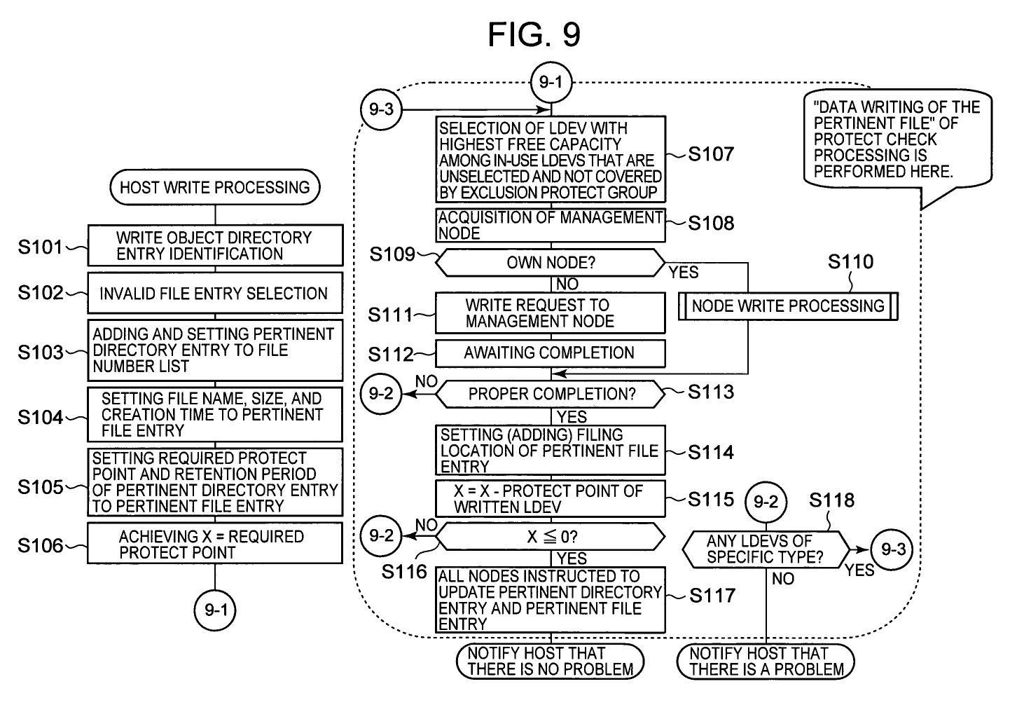

FIG. 9 illustrates an example of the flow of host write processing. In this drawing, the letter S stands for the word “step”.

The host write processing illustrated in this drawing is executed by a node 109 at the point when that node 109 receives a write request from the host. More specifically, the host write processing program 401 is executed by that node 109. In the following, when a computer program is the subject of a sentence, it will be understood that the actual processing is being performed by a CPU that executes that computer program. Also, a file of a write object designated by a write request will be called a “write file”.

In step 101, the host write processing program 401 goes through the directory management table 431 and identifies the directory entry corresponding to the directory designated by the write request. In the following description of FIG. 9, such a directory entry will be called the “pertinent directory entry”.

In step 102, the host write processing program 401 selects an invalid file entry (a file entry in which “−1” is set as the file name) from the file management table 433. In the following description of FIG. 9, such a file entry will be called the “pertinent file entry”.

In step 103, the host write processing program 401 adds a file sequence number corresponding to the pertinent file entry to the file number list of the pertinent directory entry.

In step 104, the host write processing program 401 records the file name, size, and creation time of the write file in the pertinent file entry.

In step 105, the host write processing program 401 records in the pertinent file entry the required protect point and retention period of the above-mentioned write destination directory. That is, the required protect point and retention period of the above-mentioned write destination directory are set as the required protect point and retention period of the write file. Further, in this step 105, the processing described through reference to FIG. 29A or 29B may be executed, for example. That is, the host write processing program 401 may determine the required protect point of the write file on the basis of the file attribute of the write file, or may determine whether or not the required protect point is associated with the write file, and if it is determined to be associated (for example, if it is determined that the required protect point is embedded in the write file), the host write processing program 401 may select which of the write file and the write destination directory will have priority.

In step 106, the host write processing program 401 assumes that X equals the required protect point of the write file (setting to the storage resource 277, for instance).

In step 107, the host write processing program 401 selects the LDEV with the highest free capacity among the in-use LDEVs that are unselected and are not covered by an exclusion protect group. The LDEV selected in this step 107 will be called the “selected LDEV”. The unselected LDEVs here are LDEVs that have yet to be selected as the write destination of a write file. If that write file is the first to be written, then all of the LDEVs are unselected LDEVs, but if, for example, the answer in step 118 (see below) is “yes”, the LDEV selected in step 107 will be not an unselected LDEV, but a selected LDEV. The phrase “LDEV not covered by an exclusion protect group” refers to an LDEV that is not in an exclusion protect group having a selected LDEV. By using an LDEV that satisfies this condition as the write destination, it is possible to prevent the risk that a protection object (file or directory) will be copied in an exclusion protect group and these protection objects will subsequently be lost at the same time. The phrase “in-use LDEV” refers to an LDEV corresponding to an LDEV management entry in which a value indicating that [an LDEV] is in use has been set as a use-flag. The phrase “LDEV with the highest free capacity” refers to an LDEV corresponding to the LDEV management entry with the highest free capacity out of the one or more LDEV management entries corresponding to the one or more LDEVs pertaining to the in-use LDEVs that are unselected and not covered by an exclusion protect group.

In step 108, the host write processing program 401 acquires a management node corresponding to the selected LDEV. More specifically, the host write processing program 401 acquires the management node ID recorded in the LDEV management entry corresponding to the selected LDEV.

In step 109, the host write processing program 401 determines whether or not the acquired management node is its own node, that is, whether or not it is the management node executing the host write processing program 401. If it is determined to be its own node, the flow proceeds to step 110, and otherwise the flow proceeds to step 111.

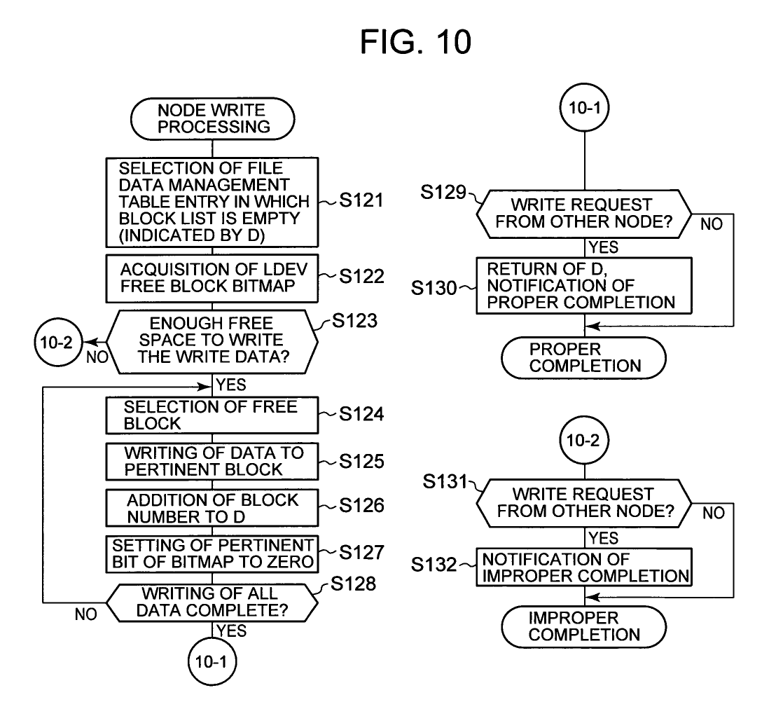

In step 110, the host write processing program 401 calls the node write processing program 403. This results in node write processing being performed. This node write processing will be discussed below through reference to FIG. 10.

In step 111, the host write processing program 401 sends the above-mentioned acquired management node a write request to request the writing of a write file. The LDEV sequence number corresponding to the selected LDEV and the size of the write file are included in this write request. As a result of this write request, the node write processing program 403 is called by the management node to which the write request is sent.

In step 112, the host write processing program 401 awaits completion. During this time, the host write processing program 401 receives notification of the completion of the write request from the management node to which the write request was sent. When a notification of proper completion is received, the host write processing program 401 receives a file data management table entry number.

In step 113, the host write processing program 401 determines whether the node write processing was completed properly or improperly (eg, whether the received completion notification is a proper completion notification or an improper completion notification). If the completion is deemed proper, the flow proceeds to step 114, and otherwise the flow proceeds to step 118.

In step 114, the host write processing program 401 records the LDEV sequence number corresponding to the selected LDEV (stored LDEV sequence number) and the received file data management table entry number to a sub-entry of the filing location list of the pertinent file entry.

In step 115, the host write processing program 401 calculates X=X−the protect point of the selected LDEV (the protect point set to the LDEV management entry corresponding to the selected LDEV). In other words, X is updated.

In step 116, the host write processing program 401 determines whether or not the updated X is less than or equal to zero. The fact that the updated X is less than or equal to zero means that storage control that satisfies the required protect point of the write file has been executed, that is, that storage control of the write file of a required protect point “n” has been executed such that the sum of the one or more protect points of the one or more LDEVs in which the write file is stored is equal to or greater than the required protect point “n”. If the updated X is less than or equal to zero, the flow proceeds to step 117, but if the updated X is over zero, the flow proceeds to step 118.

In step 117, the host write processing program 401 instructs all of the other nodes 109 to update the pertinent directory entry and the pertinent file entry. The directory sequence number corresponding to the pertinent directory entry, the various information elements recorded to the pertinent directory entry after update, the file sequence number corresponding to the pertinent file entry, and the various information elements recorded to the pertinent file entry after update, for example, are conveyed in the above-mentioned instruction. This allows the pertinent directory entry in the directory management table 431 and the pertinent file entry in the file management table 433 of all the other nodes 109 to be identified from the reported directory number and file number, respectively, and to be updated on the basis of the reported information elements, and as a result, the contents of the directory management table 431 and the file management table 433 will be the same for all of the nodes 109. After this, the host write processing program 401 notifies the host 101 to which the write request was sent that everything is as it should be.

In step 118, the host write processing program 401 determines whether or not there is still a specific type of LDEV. The “specific type of LDEV” referred to here is an in-use LDEV that has not been selected and is not covered by an exclusion protect group. If it is determined that there is such an LDEV, the flow returns to step 107, and otherwise the host write processing program 401 notifies the host 101 to which the write request was sent that there is a problem.

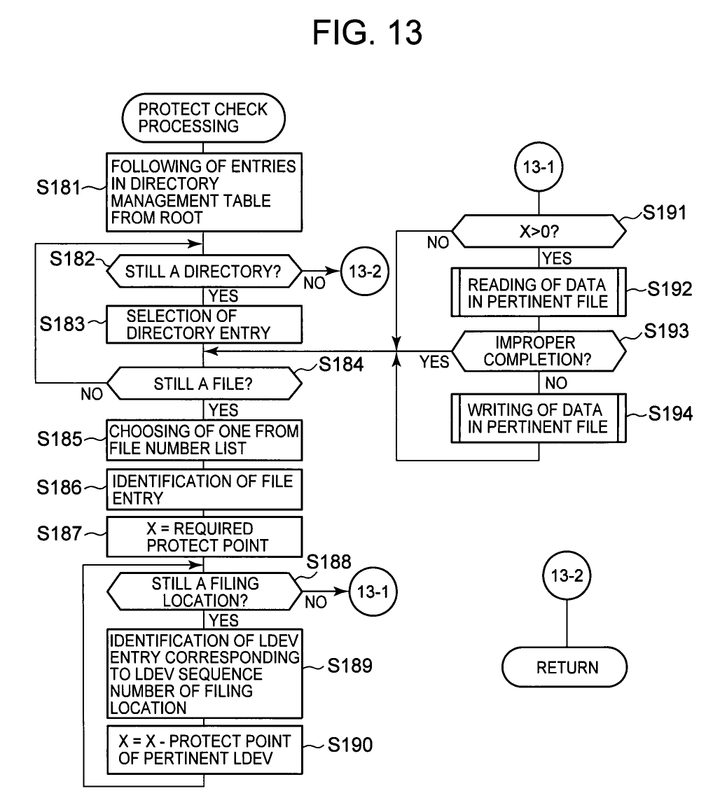

The above is a description of host write processing. The processing shown within the dotted line in FIG. 9, that is, the processing from steps 107 to 118, is executed in step 194, which entails “data writing of the pertinent file” of protect check processing (see FIG. 13).

FIG. 10 illustrates an example of the flow of node write processing.

The node write processing shown in this drawing is processing in which the block data corresponding to a file is actually written to an LDEV. If the management node is the node executing the host write processing (own node) in the host write processing discussed above, [node write processing] is executed as part of the host write processing in this own node, and if the management node is not this own node (that is, if it is another node), then [node write processing] is executed by the other node in response to a write request from the own node. More specifically, [node write processing] is executed by the node write processing program 403 in the own node or another node.

In step 121, the node write processing program 403 selects a file data management table entry in which the block list is empty (null, for example). The entry that is selected will be called the “selected entry” in the following description of FIG. 10 (indicated by the letter D in FIG. 10).

In step 122, the node write processing program 403 acquires the LDEV free block bitmap 437 corresponding to the selected LDEV (the LDEV selected in step 107 in FIG. 9).

In step 123, the node write processing program 403 determines whether or not there is enough free space in the selected LDEV to write the block data that makes up the write file. More specifically, for example, the node write processing program 403 determines whether or not the free space ascertained by the LDEV free block bitmap 437 acquired above is greater than or equal to the size of the write file. If it is determined that there is enough space to write, the flow proceeds to step 124, and otherwise the flow proceeds to step 131.

In step 124, the node write processing program 403 selects a free block from the selected block. Then the node write processing program 403 writes the block data of the write file to the selected free block (step 125), records the number of the free block (step 126), and sets the bit corresponding to the free block (a bit on the LDEV free block bitmap 437) to a value (such as zero) that means that the data has been written (step 127). Steps 124 to 127 are executed for all the block data that makes up the write file (No in step 128), and once [the processing] is completed (Yes in step 128), the flow proceeds to step 129.

In step 129, the node write processing program 403 determines whether or not [the processing] has been executed according to the write request from another node (the node executing the host write processing program 401). If [the processing] has been executed according to the write request from the other node (Yes in step 129), the node write processing program 403 returns the file data management table entry number of the selected entry to the other node, and notifies the other node that [the processing] has been completed properly (step 130), and [the processing] is completed properly. On the other hand, if the node write processing program 403 has not executed the write request from the other node, then the node write processing program 403 is ended properly without first performing step 130.

In step 131, the node write processing program 403 determines whether or not [the processing] has been executed according to a write request from another node (the node executing the host write processing program 401). If [the processing] has been executed according to a write request from the other node (Yes in step 131), then the node write processing program 403 sends a notice of improper completion to the other node (step 132), and [the processing] is completed improperly. On the other hand, if the node write processing program 403 has not executed the write request from the other node, then the node write processing program 403 is ended improperly without first performing step 132.

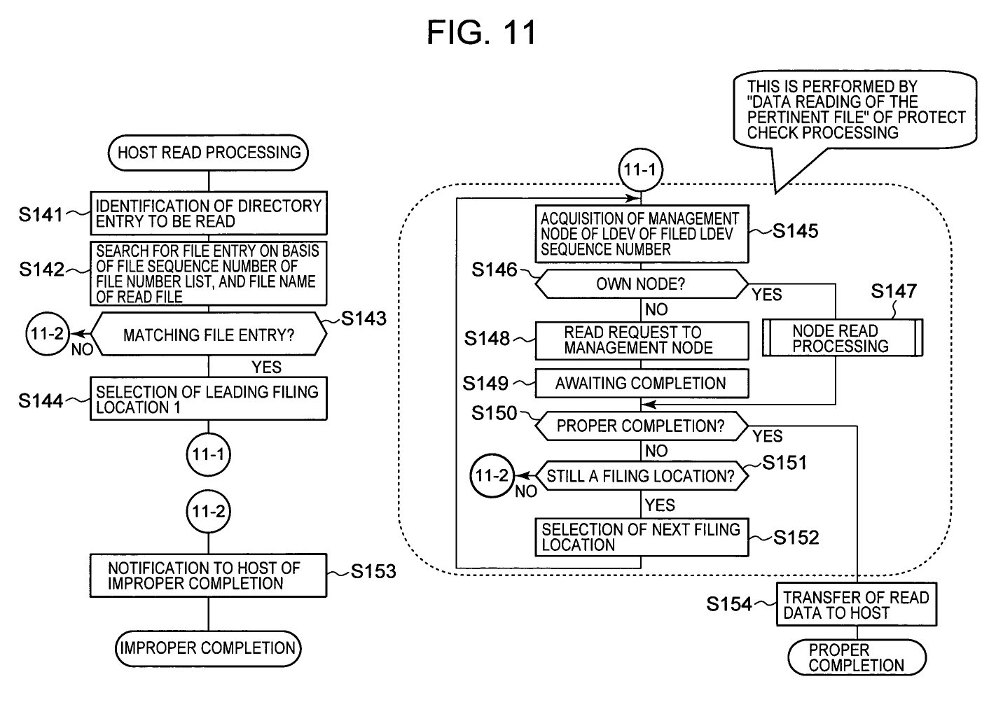

FIG. 11 illustrates an example of the flow of host read processing.

The host read processing shown in this drawing is executed by a node 109 when that node 109 receives a read request from the host. More specifically, [the processing] is executed by the host read processing program 405 in that node 109. A file designated by a read request to be read will hereinafter be referred to as a “read file”.

In step 141, the host read processing program 405 goes through the directory management table 431 and identifies the directory entry corresponding to the directory designated by the read request. In the following description of FIG. 11, such a directory entry will be called the “pertinent directory entry”.

In step 142, the host read processing program 405 searches for the file entry in which the name of the read file is recorded, from the one or more file entries corresponding to the one or more file sequence numbers on the file number list of the pertinent directory entry. If the file entry is found (Yes in step 143), the flow proceeds to step 144, and if the file entry is not found (No in step 143), the flow proceeds to step 153.

In step 144, the host read processing program 405 selects the leading sub-entry (filing location 1) in the filing location list of the found file entry.

In step 145, the host read processing program 405 acquires the LDEV entry corresponding to the stored LDEV sequence number recorded to the selected sub-entry (filing location 1), and acquires a management node ID from the LDEV entry.

In step 146, the host read processing program 405 determines whether or not the management node corresponding to the acquired management node ID is its own node (that is, whether or not it is the management node executing the host read processing program 405). If it is determined to be its own node, the flow proceeds to step 147, and otherwise the flow proceeds to step 148.

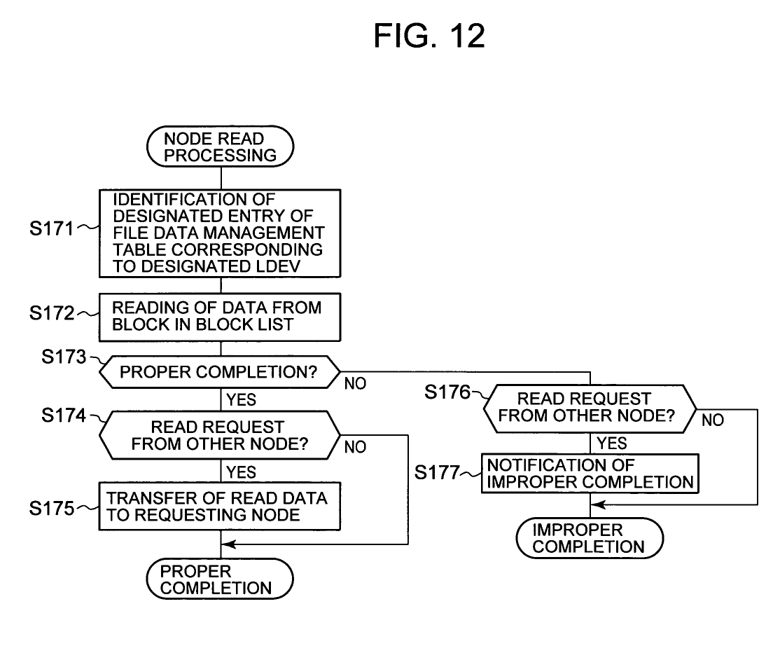

In step 147, the host read processing program 405 calls the node read processing program 407. This results in node read processing being performed. This node read processing will be discussed below through reference to FIG. 12.

In step 148, the host read processing program 405 sends a read request for requesting the reading of a read file to the node corresponding to the above-mentioned acquired management node ID. In this read request are recorded the read size and the stored LDEV sequence number and file data management table entry number recorded to the above-mentioned selected sub-entry. Node read processing is performed in response to this read request by the management node to which the read request was sent, and this results in the block data that makes up the read file being read out.

In step 149, the host read processing program 405 awaits completion. During this time, the host read processing program 405 receives notification of the completion of the read request from the management node to which the read request was sent. When a notification of proper completion is received, the host read processing program 405 receives the block data that makes up the read file.

In step 150, the host read processing program 405 determines whether the node read processing was completed properly or improperly (eg, whether the received completion notification is a proper completion notification or an improper completion notification). If the completion is deemed proper, the flow proceeds to step 154, and otherwise the flow proceeds to step 151.

In step 151, the host read processing program 405 determines whether or not there is a next sub-entry (filing location) that is unselected in this host read processing. If there is, the next sub-entry is selected (step 152) and step 145 is executed again, but if there is not, the flow proceeds to step 154.

In step 153, the host read processing program 405 notifies the host 101 of proper completion.

In step 154, the host read processing program 405 sends the host 101 the read file made up of the block data that has been read.

The above is a description of host read processing. The processing shown within the dotted line in FIG. 11, that is, the processing from steps 145 to 152, is executed in step 192, which entails “data reading of the pertinent file” of protect check processing (see FIG. 13).

FIG. 12 illustrates an example of the flow of node read processing.

The node read processing shown in this drawing is processing in which the block data corresponding to a file is actually read from an LDEV. If the management node is the node executing the host read processing (own node) in the host read processing discussed above, [node read processing] is executed as part of the host read processing in this own node, and if the management node is not this own node (that is, if it is another node), then [node read processing] is executed by the other node in response to a read request from the own node. More specifically, [node read processing] is executed by the node read processing program 407 in the own node or another node.

In step 171, the node read processing program 407 identifies, from the file management table 433, the designated file data management table entry of the file data management table corresponding to the stored LDEV sequence number designated in the host read processing.

In step 172, the node read processing program 407 identifies the one or more blocks in which block data is stored in the LDEV corresponding to the above-mentioned designated stored LDEV sequence number, from the block list in the identified file data management table entry. The node read processing program 407 reads the block data from the one or more identified blocks.

In step 173, the node read processing program 407 determines whether or not the completion was proper. If the completion is deemed proper, the flow proceeds to step 174, and otherwise the flow proceeds to step 176. For instance, if the total size of the one or more [blocks of] block data that have been read is equal to or greater than the designated read size, the completion is deemed proper, and otherwise the completion is deemed improper.

In step 174, the node read processing program 407 determines whether or not [the processing] has been executed according to the read request from another node (the node executing the host read processing program 405). If [the processing] has been executed according to the read request from the other node, the node read processing program 407 sends a proper completion notice and the block data that has been read to the other node (step 175), and [the processing] is completed properly. On the other hand, if the node read processing program 407 has not executed the read request from the other node, then the node read processing program 407 is ended properly without first performing step 175.

In step 176, the node read processing program 407 determines whether or not [the processing] has been executed according to a read request from another node (the node executing the host read processing program 405). If [the processing] has been executed according to a read request from the other node, then the node read processing program 407 sends a notice of improper completion to the other node (step 177), and [the processing] is completed improperly. On the other hand, if the node read processing program 407 has not executed the write request from the other node, then the node read processing program 407 is ended improperly without first performing step 177.

FIG. 13 illustrates an example of the flow of protect check processing.

Protect check processing is processing in which it is determined whether or not the required protect point has been satisfied for all the files that have been stored in the storage system 107, and if not, data is copied so as to satisfy this. Protect check processing is executed by the protect check processing program 411.

The protect check processing program 411 follows the directory entries in the directory management table 431 from the root (step 181). That is, the protect check processing program 411 uses the cub directory number list recorded to the directory entries of the root directory to follow the directory entries.

As a result, if there is an unselected directory entry in this protect check processing (Yes in step 182), the protect check processing program 411 selects the directory entry (step 183).

If there are one or more unselected files in this protect check processing in the file number list of the directory entry selected in step 183 (Yes in step 184), the protect check processing program 411 selects one file sequence number from among these one or more file sequence numbers (step 185).

In step 186, the protect check processing program 411 identifies the file entry corresponding to the file sequence number selected in step 185.

In step 187, the protect check processing program 411 achieves X=the required protect point of the file corresponding to the identified file entry (set to the storage resource 277, for example). This file will be called the “pertinent file” in the following description of FIG. 13.

If there are one or more unselected sub-entries (filing locations) in this protect check processing on the filing location list of the file entry corresponding to the pertinent file (Yes in step 188), the protect check processing program 411 selects one sub-entry from the one or more unselected sub-entries, and identifies the LDEV entries corresponding to the stored LDEV sequence numbers in these sub-entries (step 189).

In step 190, the protect check processing program 411 calculates X=X−the protect point of the pertinent LDEV (the protect point recorded to the identified LDEV entry). In other words, X is updated.

If the updated X is greater than zero, the protect check processing program 411 moves to step 192 and beyond. That is, since the required protect point has not be satisfied, the pertinent file is read, and the pertinent file that has been read is written to an LDEV in which the pertinent file has not yet been stored (in other words, the pertinent file is copied).

More specifically, the protect check processing program 411 calls the host read processing program 405, and step 192, that is, the reading of the data in the pertinent file (the step surrounded by the dotted line in FIG. 11), is executed by the host read processing program 405 (the protect check processing program 411 may also execute step 192 itself). If the reading of the data in the pertinent file is completed improperly (Yes in step 193), the flow proceeds to step 184, but if the completion is proper (No in step 193), the protect check processing program 411 calls the host write processing program 401, and the writing of the data in the pertinent file (the step surrounded by the dotted line in FIG. 9) is executed by the host write processing program 401 (the protect check processing program 411 may also execute step 194 itself).

The protect check processing that has begun is executed for all files belonging to the root directory.

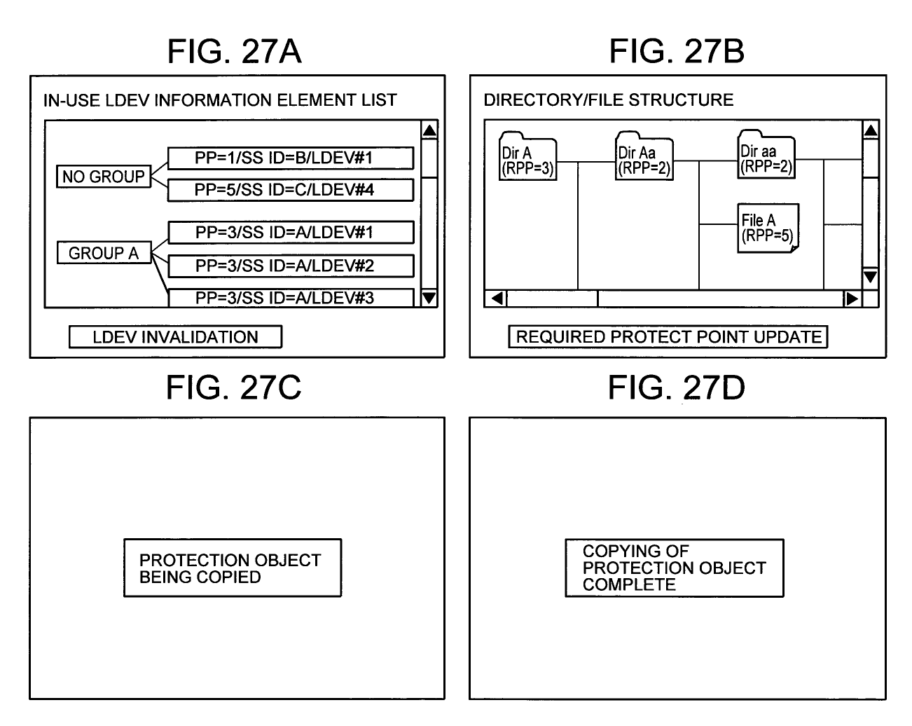

As a result of the above protect check processing, if the total value of the protect points of the one or more LDEVs in which the pertinent file is stored does not satisfy the required protect point of the pertinent file, then copying of the pertinent file is executed until this total value is equal to or greater than the required protect point. This makes it possible to protect the pertinent file that satisfies the required protect point. Furthermore, when the copying of the pertinent file is in progress (when step 192 has begun, for example), the protect check processing program 411 may notify the management console 103 that copying is in progress, and the management console 103 may display a screen indicating that copying is in progress (FIG. 27C, for example). Also, when this copying is finished (such as when step 194 is ended, or when the protect check processing is finished), the protect check processing program 411 may notify the management console 103 that copying is finished, and the management console 103 may display a screen indicating that copying is finished (FIG. 27D, for example).

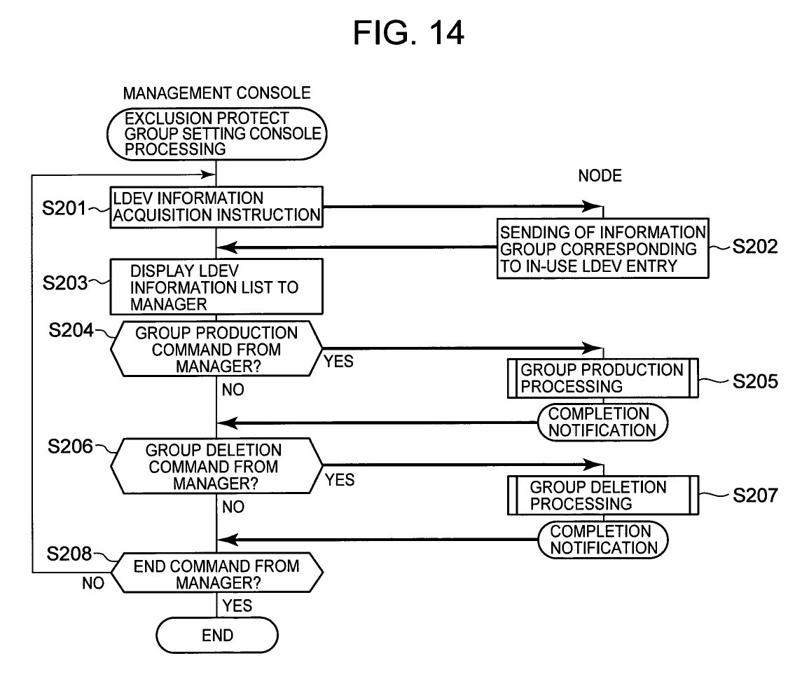

FIG. 14 illustrates an example of the flow of setting an exclusion protect loop.

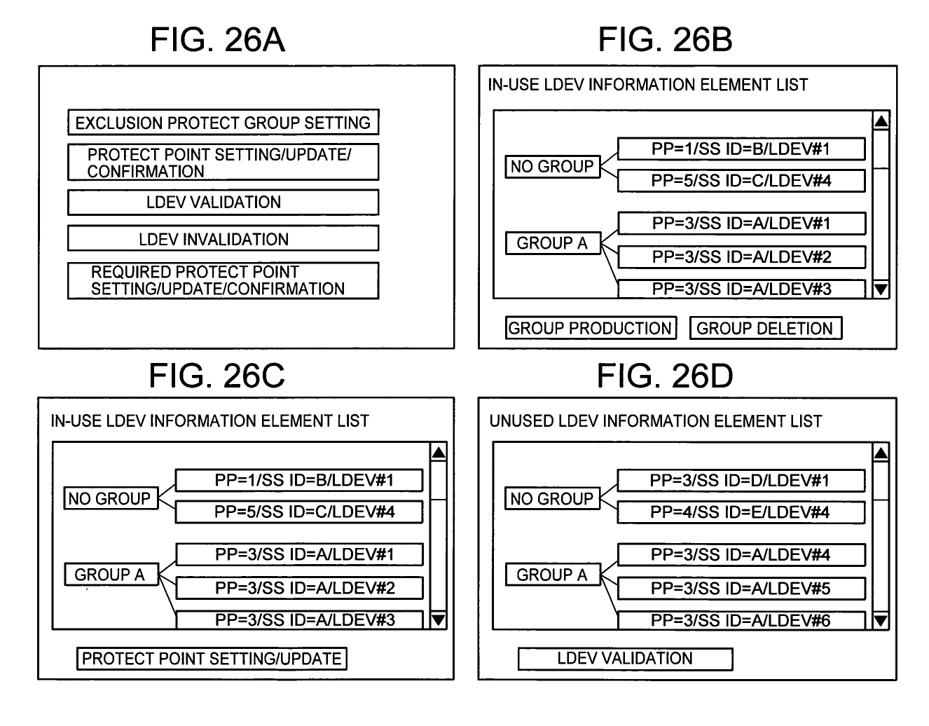

This flow begins, for example, when a manager instructs the management console 103 to set an exclusion protect group. More specifically, for example, when the manager uses the input device 179 of the management console 103 to actuate the management software 513, the setting control program 501 displays a management menu screen, an example of which is shown in FIG. 26A, on the display device 175. Upon receiving from the manager the input of selecting the “exclusion protect group setting” on the management menu screen, the setting control program 501 calls the exclusion protect group setting program 503.

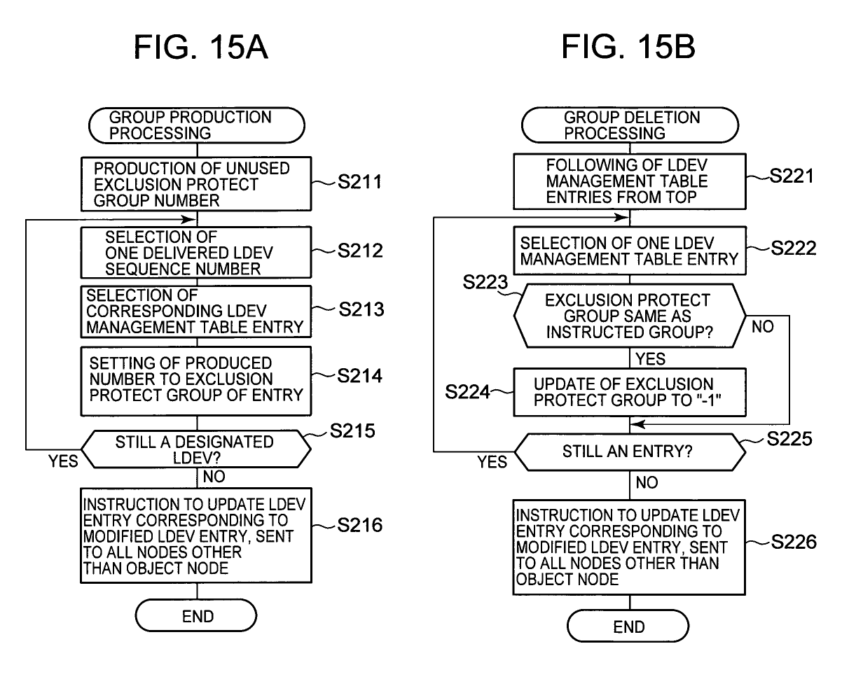

In step 201, the exclusion protect group setting program 503 in the management console 103 sends an LDEV information acquisition instruction (an instruction to acquire information related to the LDEVs in use) to any of the plurality of nodes 109 (such as a specific node 109). In the following description of FIGS. 14, 15A, and 15B, the node to which the LDEV information acquisition instruction is sent will be called the “object node”.

In step 202, the management communication program 409 in the object node 109 receives the LDEV information acquisition instruction, identifies an LDEV entry whose use-flag indicates that it is in use (hereinafter referred to as an in-use LDEV entry) according to the LDEV information acquisition instruction, and sends the management console 103 the one or more information groups corresponding to the one or more in-use LDEV entries that have been identified (a single information group is called an “LDEV information group”). An LDEV information group includes the LDEV sequence number corresponding to an LDEV entry, and the information elements recorded to an LDEV entry (hereinafter referred to as LDEV information elements). The management communication program 409 may be readied as an agent program for communication with the management console 103.

In step 203, the exclusion protect group setting program 503 in the management console 103 displays a list of LDEV information elements, divided into exclusion protect groups, on the basis of the one or more LDEV information groups received from the object node 109. The exclusion protect group setting program 503 can produce and display an in-use LDEV information element list screen, and example of which is shown in FIG. 26B, on the basis of the above-mentioned one or more LDEV information groups that are received. That is, for each of the one or more LDEVs corresponding to the one or more LDEV information groups, whether or not it belongs to an exclusion protect group, and if it does, to which exclusion protect group it belongs, for example, can be identified from the above-mentioned one or more LDEV information groups that are received, and the above-mentioned in-use LDEV information element list screen can be produced and displayed (for instance, the protect point (PP), sub-system ID (SSID), and LDEV number (LDEV #) are displayed). The exclusion protect group setting program 503 can receive from the manager a request to produce or delete an exclusion protect group. In the production of an exclusion protect group, for example, the designation of a plurality of LDEVs not belonging to any exclusion protect group and an instruction to produce a group are received. In the deletion of an exclusion protect group, the designation of an exclusion protect group and an instruction to delete a group are received.

If the exclusion protect group setting program 503 in the management console 103 receives from the manager a command to produce an exclusion protect group (Yes in step 204), it produces a group production instruction including a plurality of LDEV sequence numbers corresponding the plurality of LDEVs included in one of the exclusion protect groups, and sends this group production instruction to the object node 109. Each of the plurality of LDEVs is an LDEV designated by the manager on the in-use LDEV information element list screen.

The management communication program 409 in the object node 109 calls the group production processing program 413 in response to the group production instruction. The group production processing program 413 executes group production processing (step 205). Once it finishes the group production processing, the group production processing program 413 sends a management report to the management console 103.

If the exclusion protect group setting program 503 in the management console 103 receives from the manager a command to delete an exclusion protect group (Yes in step 206), it produces a group deletion instruction including the ID of the exclusion protect group to be deleted, and sends this group deletion instruction to the object node 109. The exclusion protect group to be deleted is an exclusion protect group designated by the manager on the in-use LDEV information element list screen, for example.

The management communication program 409 in the object node 109 calls the group deletion processing program 415 in response to the group deletion instruction. The group deletion processing program 415 executes processing group deletion (step 207). Once it finishes the group production processing, the group deletion processing program 415 sends a management report to the management console 103.

When the exclusion protect group setting program 503 in the management console 103 receives an end command from the manager (Yes in step 208), the program ends.

FIG. 15A illustrates an example of the flow of group production processing.

The group production processing program 413 produces an ID (such as a number) of an exclusion protect group that is not in use (step 211). Whether or not a used exclusion protect group ID is possible can be ascertained, for example, by referring to all the LDEV entries in the LDEV management table 429, so an ID other than an exclusion protect group ID that has been ascertained to be used can be produced.

The group production processing program 413 selects one of the plurality of LDEV sequence numbers included in the above-mentioned group production instruction (step 212), identifies the LDEV entry corresponding to the selected LDEV sequence number (step 213), and registers the unused exclusion protect group ID produced above in the identified LDEV entry.

The processing in steps 212 to 214 is executed for each of the plurality of LDEV sequence numbers included in the above-mentioned group production instruction (No in step 215). When steps 212 to 214 have been performed for all of the plurality of LDEV sequence numbers (Yes in step 215), step 216 is executed. That is, the group production processing program 413 instructs all entries LDEV entries corresponding to all of the LDEV entries that have been updated [in the object node 109]. More specifically, for example, the group production processing program 413 sends an update instruction along with a set of the LDEV sequence numbers and updated exclusion protect group IDs for every one of the LDEV entries that have been updated. As a result, all the other nodes 109 receive a set of LDEV sequence numbers and updated exclusion protect group IDs, and register the updated exclusion protect group IDs corresponding to the LDEV sequence numbers in the LDEV entries corresponding to the received LDEV sequence numbers in response to the update instruction. Accordingly, the contents of the LDEV management table 429 will be the same in all of the nodes 109.

FIG. 15B illustrates an example of the flow of group deletion processing.

The group deletion processing program 415 goes through the LDEV management table 429 from the top (starting with the leading entry and continuing on to the last entry) (step 221).

The group deletion processing program 415 selects an unselected LDEV entry in this group deletion processing (step 222), and determines whether or not the exclusion protect group ID recorded to that LDEV entry is the same as the exclusion protect group ID recorded in the group deletion processing (step 223). If it is deemed to be the same (Yes in step 223), the flow proceeds to step 224, and if it is deemed to be different (No in step 223), the flow proceeds to step 225.

In step 224, the group deletion processing program 415 updates the exclusion protect group ID recorded to the LDEV entry to a value that means invalid (such as “−1”).

In step 225, the group deletion processing program 415 determines whether or not any unselected LDEV entry still remains in this group deletion processing. If one is deemed to remain (Yes in step 225), the flow goes back to step 222, and otherwise (No in step 225) the flow proceeds to step 226.

In step 226, the group deletion processing program 415 instructs all of the other nodes besides the object node to update the LDEV entries corresponding to each of the LDEV entries that have been updated. More specifically, for example, the group deletion processing program 415 sends an update instruction along with the LDEV sequence numbers and the updated exclusion protect group IDs (invalid value) for each of the LDEV entries that have been updated. As a result, all of the other nodes 109 receive a set of LDEV sequence numbers and updated exclusion protect group IDs (invalid value), and the updated exclusion protect group IDs (invalid value) corresponding to the LDEV sequence numbers are recorded to the LDEV entries corresponding to the received LDEV sequence numbers. Accordingly, the contents of the LDEV management tables 429 will be the same for all of the nodes 109. Further, instead of sending updated exclusion protect group IDs (invalid value), an instruction to update the exclusion protect group IDs of LDEV entries corresponding to the sent LDEV sequence numbers to an invalid value may be sent.

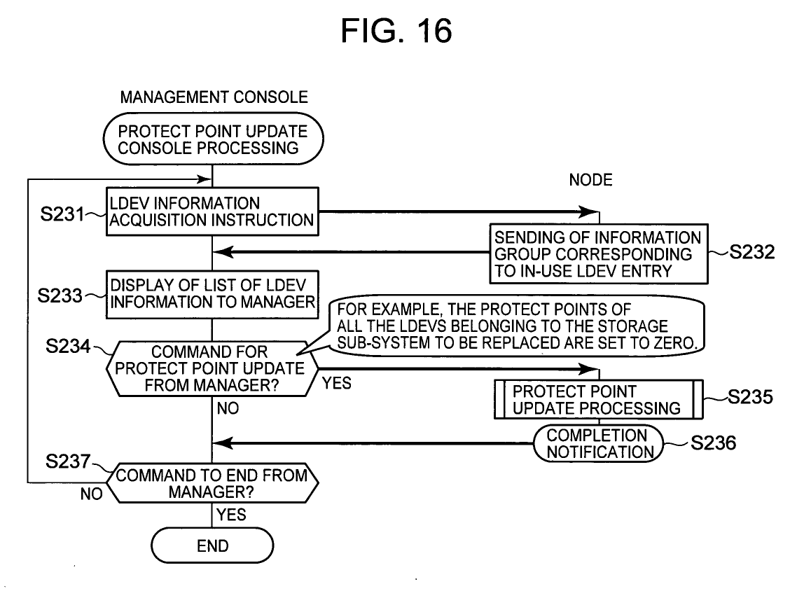

FIG. 16 illustrates an example of the flow of updating a protect point.

This flow begins, for example, when a manager inputs an exclusion protect group setting to the management console 103. More specifically, for example, the setting control program 501 calls the protect point management program 505 when the input of selection of “protect point setting/update/confirmation” on the management menus screen shown in FIG. 26A, for example, is received from the manager.

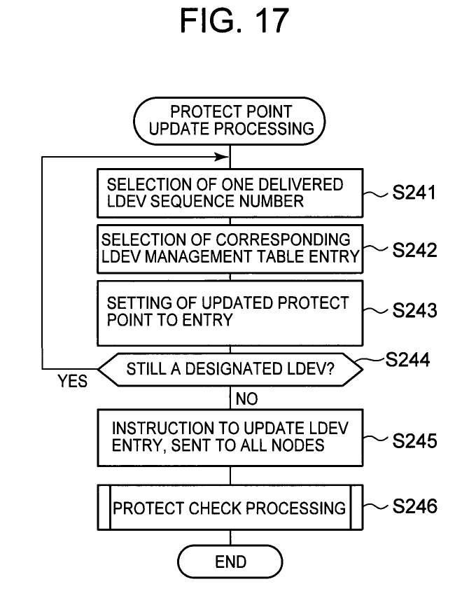

In step 231, the protect point management program 505 in the management console 103 sends an LDEV information acquisition instruction (an instruction to acquire information related to an in-use LDEV) to any of the plurality of nodes 109 (such as a specific node 109). In the following description of FIGS. 16 and 17, the node to which the LDEV information acquisition instruction is sent will be called the “object node”.

In step 232, the management communication program 409 in the object node 109 receives an LDEV information acquisition instruction, identifies the in-use LDEV entry according to the LDEV information acquisition instruction, and sends to the management console 103 the one or more LDEV information groups corresponding to the one or more in-use LDEV entries that have been identified.

In step 233, the protect point management program 505 in the management console 103 displays a list of the LDEV information elements on the basis of the one or more LDEV information groups received from the object node 109. For instance, the in-use LDEV information element list screen shown in FIG. 26C can be produced and displayed. The protect point management program 505 can receive from a manager a designation of the LDEV whose protect point is to be updated, and the updated protect point.

When a designation of the LDEV whose protect point is to be updated and the updated protect point are received from the manager (Yes in step 234), the protect point management program 505 in the management console 103 produces a protect point update instruction including the LDEV sequence number corresponding to the designated LDEV and the updated protect point, and sends the protect point update instruction to the object node 109. If there are a plurality of sets of the LDEV sequence number corresponding to the designated LDEV and the updated protect point, these plurality of sets are included in the protect point update instruction.

The management communication program 409 in the object node 109 calls the protect point update processing program 417 in response to the protect point update instruction. The protect point update processing program 417 executes protect point update processing (step 235). Once the protect point update processing is finished, the protect point update processing program 417 sends a completion notification to the management console 103 (step 236).

When the protect point management program 505 in the management console 103 receives an end command from the manager (Yes in step 237), the program ends.

In the above processing, if the manager performs a replacement of the storage sub-system 111, for example, then in step 234 zero is designated as the updated protect point for all of the LDEVs had by the storage sub-system 111, prior to the replacement of the storage sub-system 111. In this case, the object node 109 executes the protect point update processing discussed below, and in this protect point update processing, the above-mentioned protect point processing is also executed. Accordingly, the data in all of the LDEVs in the storage sub-system to be replaced is copied to the LDEVs in another storage sub-system. After this, the storage sub-system 111 to be replaced is removed, which allows the storage sub-system 111 to be replaced while still satisfying the required protect point that is required by the protection object (a file or directory).

FIG. 17 illustrates an example of the flow of protect point update processing.

The protect point update processing program 417 selects one LDEV sequence number from the one or more LDEV sequence numbers included in the protect point update instruction (step 241), identifies the LDEV entries corresponding to the selected LDEV sequence numbers (step 242), and registers the updated protect points corresponding to the selected LDEV sequence numbers in the identified LDEV entries (step 243).

The processing in steps 241 to 243 is executed for each of the plurality of LDEV sequence numbers included in the above-mentioned protect point update instruction (No in step 244). When steps 241 to 243 have been executed for all of these plurality of LDEV sequence numbers (Yes in step 244), step 245 is executed. That is, the protect point update processing program 417 instructs all the other nodes besides the object node to update the LDEV entries corresponding to all of the various LDEV entries that have been updated [in the object node 109]. More specifically, for example, the protect point update processing program 417 sends an update instruction along with a set of the LDEV sequence numbers and updated protect points for every one of the LDEV entries that have been updated. As a result, all the other nodes 109 receive a set of LDEV sequence numbers and updated protect points, and register the updated protect points corresponding to the LDEV sequence numbers in the LDEV entries corresponding to the received LDEV sequence numbers in response to the update instruction. Accordingly, the contents of the LDEV management table 429 will be the same in all of the nodes 109.

After this, the protect point update processing program 417 calls the protect check processing program 411. An example of a situation in which this call would be made is when a notification of the completion of updating has been received from all the other nodes. The protect check processing program 411 executes protect check processing (see FIG. 13).

When the protect point of a LDEV is updated, there is the risk that the required protect point of the protection object (file or directory) stored in the LDEV will not be satisfied, but protect check processing is executed when a protect point is updated. As a result, if there is a protection object whose required protect point is not satisfied, the protection object is detected and copied to another LDEV, so protection is performed in which the required protect point of the protection object is satisfied.

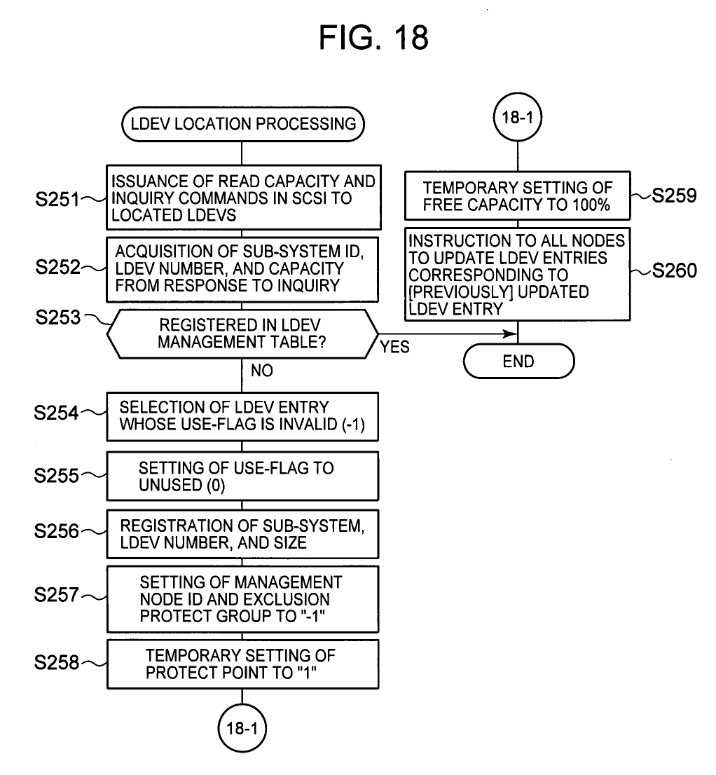

FIG. 18 illustrates an example of the flow of LDEV location processing.

LDEV location processing is processing in which information elements related to a located LDEV are acquired from the storage sub-system 111 having that LDEV, and the acquired information elements are registered in the LDEV management table 429. LDEV location processing is executed, for example, by the LDEV location processing program 425 in a node 109 in which a new LDEV has been found. A new LDEV can be located, for example, by sending a specific inquiry command (such as a REPORT_LUNS command with a SCSI) to the respective storage sub-systems 111 from the node 109.

The LDEV location processing program 425 sends a specific query command (such as READ_CAPACITY and an inquiry command supported by SCSI) to the located LDEV (called the object LDEV in the description of FIG. 18 here) (step 251). The LDEV location processing program 425 receives a response include the sub-system ID of the storage sub-system having the object LDEV and the LDEV number managed by the storage sub-system (the LDEV number corresponding to the object LDEV) from the storage sub-system 111 having the object LDEV, and acquires the sub-system ID, LDEV number, and capacity from the response (step 252). The sub-system ID, LDEV number, and capacity may instead, for example, be acquired from a response to an inquiry to the management software 513, or acquired by utilizing a SCSI sense command, or subsequently set by the manager from the management console 103.

The LDEV location processing program 425 determines whether or not the acquired sub-system ID and LDEV number have been registered in the LDEV management table 429 (step 253). If they are determined to have been registered (Yes in step 253), the processing is ended, and otherwise (No in step 253) the flow proceeds to step 254.

The LDEV location processing program 425 selects an LDEV entry whose use-flag is invalid (such as “−1”) (step 254), and sets a value indicating that [the entry] has not been used (such as zero) as a use-flag to the selected LDEV entry (step 255). Also, the LDEV location processing program 425 registers the above-mentioned acquired sub-system ID, LDEV number, and capacity in the selected LDEV entry (step 256). Also, the LDEV location processing program 425 sets an invalid value (such as “−1”) as the management node ID and exclusion protect group ID for the selected LDEV entry (step 257), temporarily sets “1” as the protect point (step 258), and temporarily sets “100%” as the free capacity (step 259). Furthermore, for example, the LDEV location processing program 425 may send a specific query command (such as an inquiry command) to each of the storage sub-systems 111, thereby acquiring from each storage sub-system 111 information related to the various LDEVs (such as their protect points, RAID levels, and free capacity), and may set the acquired information to the above-mentioned selected LDEV entry. Also, the protect points of the various LDEVs may be determined and set by the LDEV location processing program 425 on the basis of the RAID levels included in the acquired information, for example.

In step 260, the LDEV location processing program 425 instructs all of the other nodes 109 in which this LDEV location processing is being performed to update the LDEV entries corresponding to all of the various LDEV entries that have been updated. More specifically, for example, the LDEV location processing program 425 sends an update instruction along with the LDEV sequence numbers and updated information elements for every one of the LDEV entries that have been updated. As a result, all of the other nodes 109 receive a set of LDEV sequence numbers and updated information elements, and register, in response to the update instruction, the updated information elements corresponding to the LDEV sequence numbers (such as a use-flag “0”, sub-system ID, LDEV number, capacity, a management node ID “−1”, an exclusion protect group ID “−1”, a protect point “1,” and a free capacity “100%”) in the LDEV entries corresponding to the received LDEV sequence numbers.

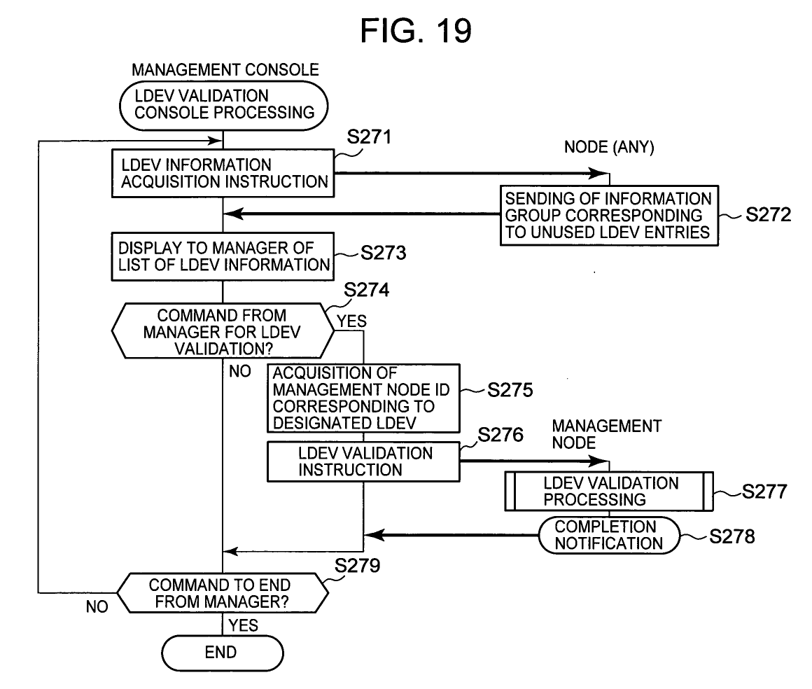

FIG. 19 illustrates an example of the flow of LDEV validation.

This flow commences, for example, when the manager commands the management console 103 to perform LDEV validation. More specifically, for example, the setting control program 501 calls the LDEV validation program 507 upon receiving from the manager an input of selection of “LDEV validation” on the management menu screen shown in FIG. 26A.

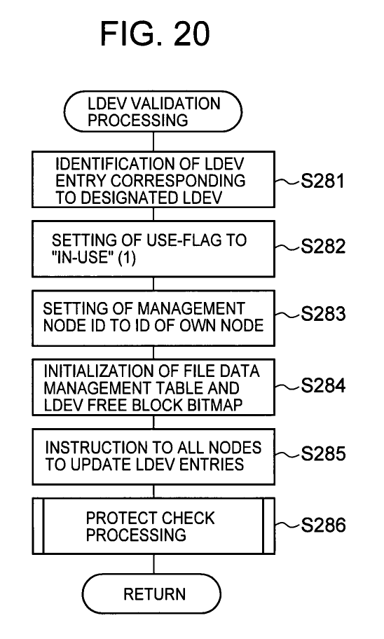

In step 271, the LDEV validation program 507 in the management console 103 sends an LDEV information acquisition instruction (an instruction to acquire information related to unused LDEVS) to any of the plurality of nodes 109 (such as any one node 109). The node to which the LDEV information acquisition instruction is sent will be called the “object node” in the following description of FIGS. 19 and 20.

In step 272, the management communication program 409 in the object node 109 receives an LDEV information acquisition instruction, identifies unused LDEV entries according to the LDEV information acquisition instruction, and sends to the management console 103 one or more LDEV information groups corresponding to the one or more unused LDEV entries that have been identified.

In step 273, the LDEV validation program 507 in the management console 103 lists LDEV information elements in a table on the basis of the one or more LDEV information groups received from the object node 109. For instance, the unused LDEV information element list screen shown in FIG. 26D can be produced and displayed. The LDEV validation program 507 can receive from the manager the designation of unused LDEVs considered to be valid, and the protect points associated with the LDEVs.

When the LDEV validation program 507 in the management console 103 receives from the manager the designation of unused LDEVs to be made valid and the protect points associated with the LDEVs (Yes in step 274), it acquires a management node ID from the LDEV information group corresponding to the unused LDEVs (step 275). The LDEV validation program 507 produces an LDEV validation instruction including protect points and the LDEV sequence numbers of unused LDEVs, and sends the LDEV validation instruction thus produced to the management node corresponding to the acquired management node ID. Furthermore, no protect point may be included in the LDEV validation instruction when, for example, the LDEV validation program 507 has successfully acquired a protect point from the storage sub-system 111 in response to a specific query command (such as an inquiry command).

The management communication program 409 in the object node 109 calls the LDEV validation processing program 421 in response to the LDEV validation instruction. The LDEV validation processing program 421 executes LDEV validation processing (step 277). Once the LDEV validation processing is finished, the LDEV validation processing program 421 sends a completion notification to the management console 103 (step 278).

When the LDEV validation program 507 in the management console 103 receives an end command from the manager (Yes in step 279), the program ends.

FIG. 20 illustrates an example of the flow of LDEV validation processing.

The LDEV validation processing program 421 identifies the LDEV entry corresponding to the LDEV sequence number included in the LDEV validation instruction (step 281), and sets as a use-flag a value indicating that [an LDEV] is in use (such as “1”) in the LDEV entry (step 282). Also, the LDEV validation processing program 421 sets the ID of the object node 109 (the own node that is executing this LDEV validation processing program 421) as a management node ID in the LDEV entry (step 283). Also, the LDEV validation processing program 421 initializes the file data management table 435 and the LDEV free block bitmap 437 corresponding to the LDEV sequence numbers included in the LDEV validation instruction (step 284).

The LDEV validation processing program 421 instructs all the other nodes besides the object node to update their LDEV entries corresponding to all of the LDEV entries that have been updated [in the object node 109] (step 285). More specifically, for example, the LDEV validation processing program 421 sends an update instruction along with a set of the LDEV sequence numbers and updated information elements for every one of the LDEV entries that have been updated. (Since the processing executed by the other nodes that have received the update instruction has already been described, it will not be repeated here.)

After this, the protect point update processing program 417 calls the protect check processing program 411. An example of a situation in which this call would be made is when a notification of the completion of updating has been received from all the other nodes. The protect check processing program 411 executes protect check processing (see FIG. 13). Protect check processing does not necessarily need to be performed in the LDEV validation processing.

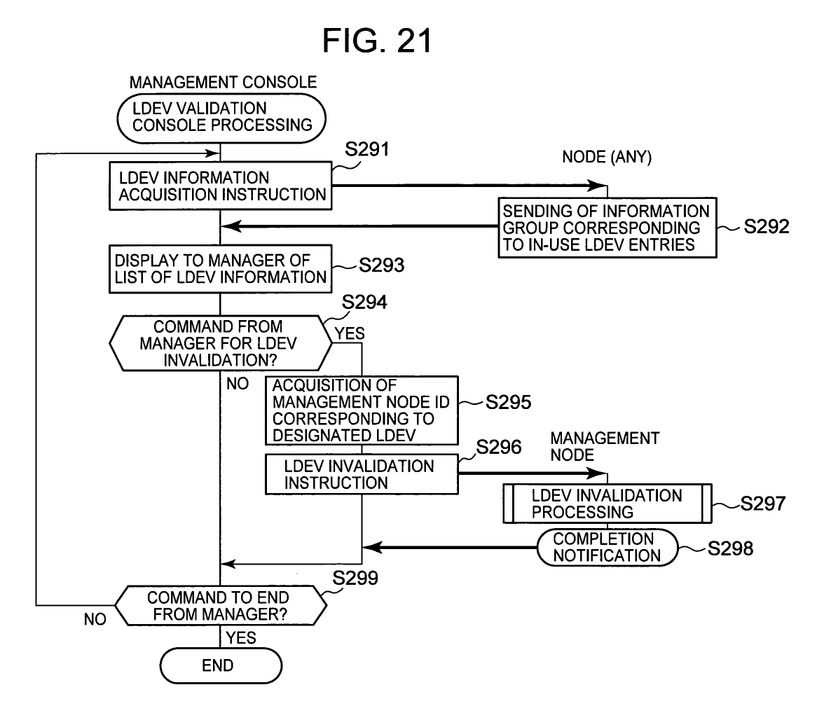

FIG. 21 illustrates an example of the flow of LDEV invalidation.

This flow commences, for example, when the manager commands the management console 103 to perform LDEV invalidation. More specifically, for example, the setting control program 501 calls the LDEV invalidation program 509 upon receiving from the manager an input of selection of “LDEV invalidation” on the management menu screen shown in FIG. 26A.

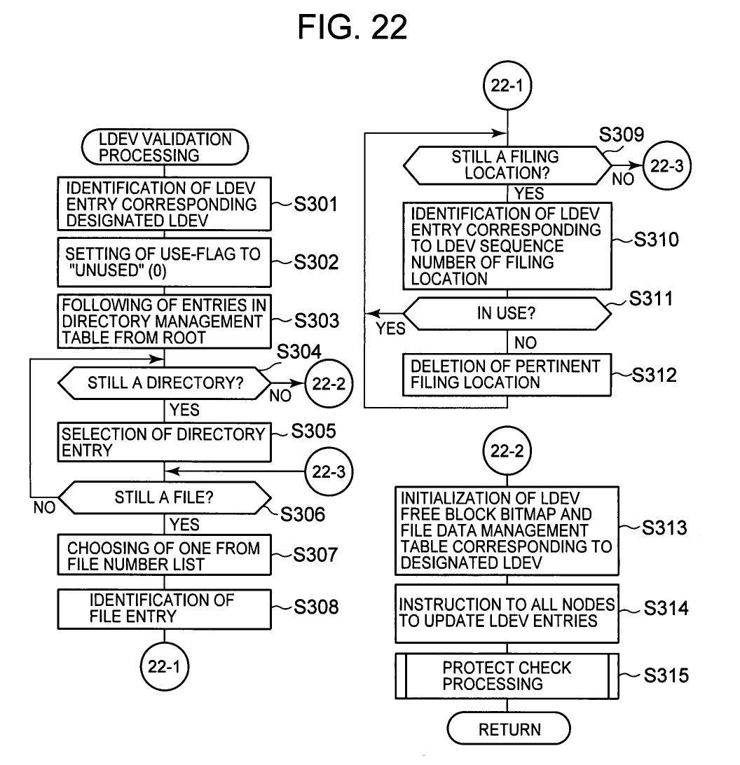

In step 291, the LDEV invalidation program 509 in the management console 103 sends an LDEV information acquisition instruction (an instruction to acquire information related to in-use LDEVs) to any of the plurality of nodes 109 (such as any one node 109). The node to which the LDEV information acquisition instruction is sent will be called the “object node” in the following description of FIGS. 21 and 22.

In step 292, the management communication program 409 in the object node 109 receives an LDEV information acquisition instruction, identifies in-use LDEV entries according to the LDEV information acquisition instruction, and sends to the management console 103 one or more LDEV information groups corresponding to the one or more in-use LDEV entries that have been identified.

In step 293, the LDEV invalidation program 509 in the management console 103 displays a list of LDEV information elements on the basis of the one or more LDEV information groups received from the object node 109. For instance, the in-use LDEV information element list screen shown in FIG. 27A can be produced and displayed. The LDEV invalidation program 509 can receive from the manager the designation of unused LDEVs considered to be invalid (and may received the designation of protect points).

When the LDEV invalidation program 509 in the management console 103 receives from the manager the designation of in-use LDEVs to be made invalid (Yes in step 294), it acquires a management node ID from the LDEV information group corresponding to the in-use LDEVs (step 295). The LDEV invalidation program 509 produces an LDEV invalidation instruction including the LDEV sequence numbers of in-use LDEVs, and sends the LDEV invalidation instruction thus produced to the management node corresponding to the acquired management node ID.

The management communication program 409 in the object node 109 calls the LDEV invalidation processing program 423 in response to the LDEV invalidation instruction. The LDEV invalidation processing program 423 executes LDEV invalidation processing (step 297). Once the LDEV invalidation processing is finished, the LDEV invalidation processing program 423 sends a completion notification to the management console 103 (step 298).

When the LDEV invalidation program 509 in the management console 103 receives an end command from the manager (Yes in step 299), the program ends.

FIG. 22 illustrates an example of the flow of LDEV invalidation processing.

LDEV invalidation processing is processing for invalidating the data in the designated LDEV.

The LDEV invalidation processing program 423 identifies the LDEV entry corresponding to the LDEV sequence number included in the LDEV invalidation instruction (step 301), and sets as a use-flag a value indicating that [an LDEV] is not in use (such as “0”) in the LDEV entry (step 302).

The LDEV invalidation processing program 423 follows the directory entries in the directory management table 431 from the root (step 303).

As a result, if there is an unselected directory entry in this LDEV invalidation processing (Yes in step 304), the LDEV invalidation processing program 423 selects the directory entry (step 305).

If there are one or more unselected files in this LDEV invalidation processing in the file number list of the directory entry selected in step 305 (Yes in step 306), the LDEV invalidation processing program 423 selects one file sequence number from among these one or more file sequence numbers (step 307), and identifies the file entry corresponding to the selected file sequence number (step 308).

If there are one or more unselected sub-entries (filing locations) in this LDEV invalidation processing on the filing location list of this file entry (Yes in step 309), the LDEV invalidation processing program 423 selects one sub-entry from the one or more unselected sub-entries, and identifies the LDEV entry corresponding to the stored LDEV sequence number in this sub-entry (step 310). If the identified LDEV entry is an in-use LDEV entry (Yes in step 311), the LDEV invalidation processing program 423 returns to step 309, but deletes the pertinent filing location (the above-mentioned selected sub-entry) (step 312) and returns to step 309 if the entry is an unused LDEV entry (No in step 311). The result of step 312 is that the next and subsequent sub-entries after the deleted sub-entry are shifted up by one place each. More specifically, for example, the information recorded in the next sub-entry after the sub-entry to be deleted can be written over the information recorded in the sub-entry.

The processing of steps 309 to 312 is repeated until the are no more unselected sub-entries (filing locations) in this LDEV invalidation processing at the filing location of the file entry identified in step 308, and once there are no more, the flow returns to step 306. If the answer is Yes in step 306, step 307 is executed, but if the answer is No in step 306, the flow returns to step 304. If the answer is Yes in step 304, step 305 is executed, but if the answer is No in step 306, the flow proceeds to step 313.

In step 313, the LDEV invalidation processing program 423 initializes the file data management table 435 and the LDEV free block bitmap 437 corresponding to the LDEV sequence numbers included in the LDEV invalidation instruction.

In step 314, the LDEV invalidation processing program 423 instructs all the other nodes besides the object node to update their LDEV entries corresponding to all of the LDEV entries and file entries that have been updated [in the object node 109].

In other words, in this LDEV invalidation processing, information that is managed in relation to data stored in an LDEV in which the use-flag of the LDEV entry has been updated from “in-use” to “unused” is destroyed. After this, the LDEV invalidation processing program 423 calls the protect check processing program 411. An example of a situation in which this call would be made is when a notification of the completion of updating has been received from all the other nodes. The protect check processing program 411 executes protect check processing (see FIG. 13).

When an LDEV is invalidated, there is the risk that the required protect point of the protection object (file or directory) stored in the LDEV will not be satisfied, but protect check processing is executed when LDEV invalidation processing has been performed. As a result, if there is a protection object whose required protect point is not satisfied, the protection object is detected and copied to another LDEV, so protection is performed in which the required protect point of the protection object is satisfied.

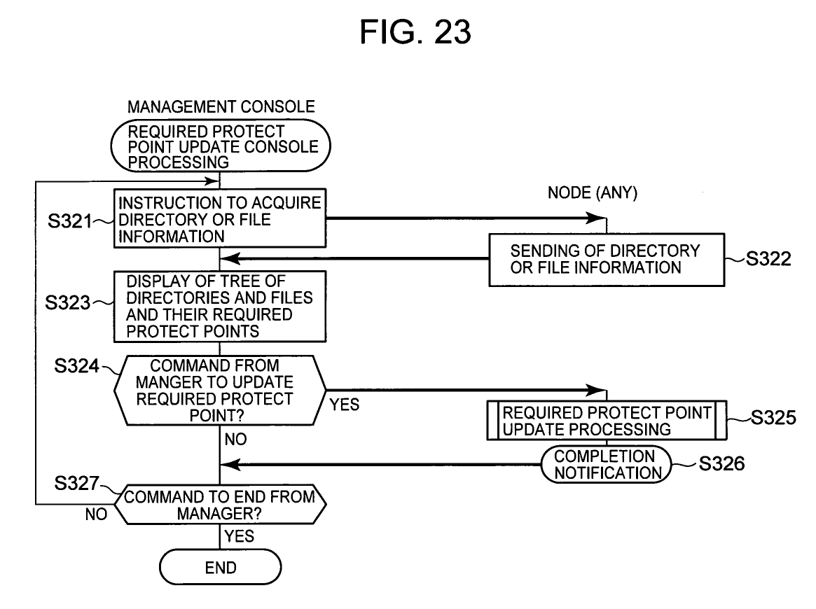

FIG. 23 illustrates an example of the flow of updating a required protect point.

This flow commences, for example, when the manager commands the management console 103 to update a required protect group. More specifically, for example, the setting control program 501 calls the required protect point management program 511 upon receiving from the manager an input of selection of “required protect point setting/update/confirmation” on the management menu screen shown in FIG. 26A.

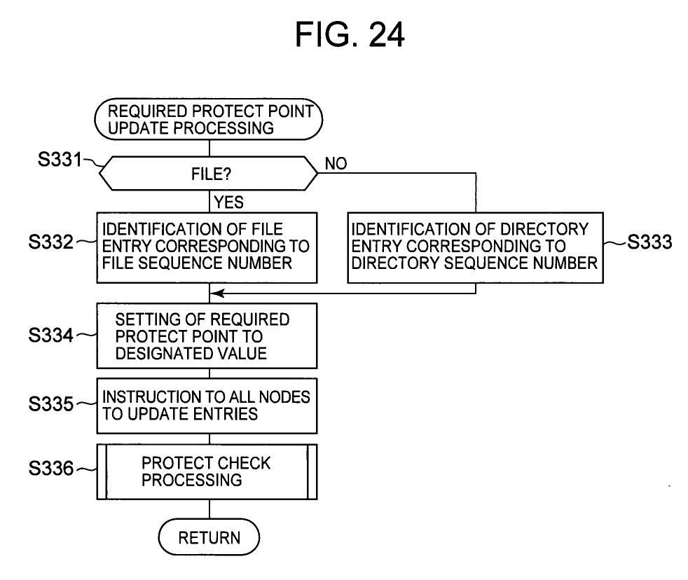

In step 321, the required protect point management program 511 in the management console 103 sends a directory or file information acquisition instruction to any of the plurality of nodes 109 (such as any one node 109). The node to which the LDEV information acquisition instruction is sent will be called the “object node” in the following description of FIGS. 23 and 24.

In step 322, the management communication program 409 in the object node 109 receives a directory or file information acquisition instruction, and sends to the management console 103 directory or file information (all of the information elements recorded in all of the directory entries of the directory management table 431, and all of the information elements recorded in all of the file entries of the file management table 433), according to the instruction.

In step 323, the required protect point management program 511 in the management console 103 ascertains the relationship of the various directories and the various files (which files are stored in which directories), and the required protect points of the various directories and the various files, on the basis of the directory or file elements from the object node 109, and displays a tree of the directories and files and their required protect points. The screen shown in FIG. 27B is an example of such a tree display screen. This screen is produced and displayed by the required protect point management program 511. A “tree display” is a display that uses a tree structure to show the relationship of directories and files, and shows the required protect points in symbols (or the vicinity thereof) representing directories and files. Instead of a tree display, another type of display may be employed which shows which files are stored in which directories and what the required protect points are of the various directories and files. Also, in the example in FIG. 27B, the symbols of the directories and files, and the text shown within these symbols (such as the directory name or file name and the required protect point) are shown enlarged in order to make them easier to see, and consequently only a narrow range of the tree structure is shown, but in actual practice a wider range can be shown in a single screen (this point can also be the same, for example, in the display of the above-mentioned list of information elements related to in-use or unused LDEVs).

When the required protect point management program 511 in the management console 103 receives from the manager a designation of a directory or file whose required protect point is to be updated, and the updated required protect point (Yes in step 324), it produces a required protect point update instruction including the updated required protect point and the directory sequence number or file sequence number corresponding to the designated directory or file, and sends the required protect point update instruction to the object node 109. If there are a plurality of updated required protect points and directory sequence numbers or file sequence numbers of the designated directories or files, these sets may be included in the required protect point update instruction.

The management communication program 409 in the object node 109 calls the required protect point update processing program 419 in response to the required protect point update instruction. The required protect point update processing program 419 executes required protect point update processing (step 325). The required protect point update processing program 419 sends a completion notification to the management console 103 one the required protect point update processing is finished (step 326).

When the required protect point management program 511 in the management console 103 receives an end command from the manager (Yes in step 327), the program ends.

FIG. 24 illustrates an example of the flow of required protect point update processing.

The required protect point update processing program 419 determines whether the sequence number included in the required protect point update instruction is a directory sequence number or a file sequence number (step 331). If the required protect point management program 511 in the management console 103 includes information indicating whether the sequence number is a directory sequence number or a file sequence number, for example, then whether the sequence number is a directory sequence number or a file sequence number can be determined by analyzing this information with the required protect point update processing program 419. If it is determined to be a file sequence number (Yes in step 331), the flow proceeds to step 332, but if it is determined to be a directory sequence number (No in step 331), the flow proceeds to step 333.

In step 332, the required protect point update processing program 419 identifies the file entry corresponding to the file sequence number. Meanwhile, in step 333, the required protect point update processing program 419 identifies the directory entry corresponding to the directory sequence number.

In step 334, the required protect point update processing program 419 sets the required protect point to the designated value in the identified file entry or directory entry. That is, the updated required protect point included in the above-mentioned required protect point update instruction is written over the [previous] required protect point.

In step 335, the required protect point update processing program 419 instructs all the other nodes besides the object node to update their file entries or directory entries corresponding to the updated file entry or directory entry.

If a plurality of sets of the updated required protect point and the directory sequence number or file sequence number of the designated directory or file are included in the above-mentioned required protect point update instruction, the processing of the above steps 331 to 335 may be executed for each of the sets.

After step 335, the required protect point update processing program 419 calls the protect check processing program 411. An example of a situation in which this call would be made is when a notification of the completion of updating has been received from all the other nodes. The protect check processing program 411 executes protect check processing (see FIG. 13).

When the required protect point is updated, there is the risk that the required protect point of the protection object (file or directory) stored in an LDEV will not be satisfied, but protect check processing is executed when a required protect point is updated. As a result, if there is a protection object whose required protect point is not satisfied, the protection object is detected and copied to another LDEV, so protection is performed in which the required protect point of the protection object is satisfied.

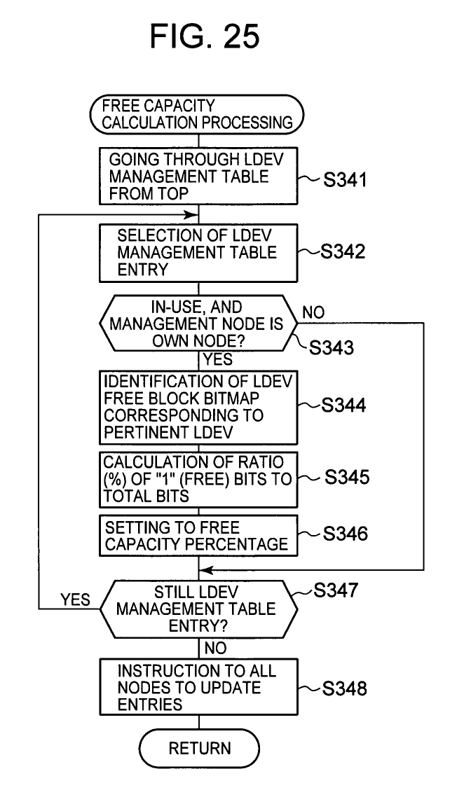

FIG. 25 illustrates an example of the flow of processing for calculating free capacity.

Free capacity calculation processing is processing by a node 109 in which the percentage of free capacity of an LDEV managed by the node 109 is calculated, and the percentage of free capacity in an LDEV entry corresponding to the LDEV is updated to the calculated percentage of free capacity. Free capacity calculation processing is executed by the free capacity calculation processing program 427, either periodically or non-periodically (such as every 30 minutes).

The free capacity calculation processing program 427 goes through the LDEV management table 429 from the top (starting from the first [entry] and continuing successively to the last) (step 341).

The free capacity calculation processing program 427 selects an unselected LDEV entry in this free capacity calculation processing (step 342), and determines, from the use-flag and the management node ID recorded to that LDEV entry, whether or not the LDEV corresponding to the LDEV entry (hereinafter referred to as the pertinent LDEV) is an in-use LDEV and the node 109 managing the pertinent LDEV is the own node (the node executing this free capacity calculation processing program 427) (step 343). If it is determined that this LDEV is an in-use LDEV and the own node is being used (Yes in step 343), the flow proceeds to step 344, and otherwise (No in step 343) the flow proceeds to step 347.

In step 344, the free capacity calculation processing program 427 identifies the LDEV free block bitmap 437 corresponding to the pertinent LDEV. In step 345, the free capacity calculation processing program 427 calculates the ratio (free capacity (%)) of the number of “1” values (a value meaning free) to the total number of bits of the identified LDEV free block bitmap 437. In step 346, the free capacity calculation processing program 427 writes the calculated free capacity over the free capacity of the LDEV entry corresponding to the pertinent LDEV.

In step 347, the free capacity calculation processing program 427 determines whether or not an unselected LDEV entry still remains in this free capacity calculation processing. If at least one is determined to remain (Yes in step 347), the flow returns to step 342, and otherwise (No in step 347) the flow proceeds to step 348.

In step 348, the free capacity calculation processing program 427 instructs all the other nodes besides the object node to update their LDEV entries corresponding to the updated LDEV entry.

The above is a description of a first embodiment.

### Second Embodiment

A second embodiment of the present invention will now be described. The description will focus on the differences from the first embodiment, and description of those areas that the two embodiments have in common will be omitted or simplified. This also applies to the third and fourth embodiments described below.

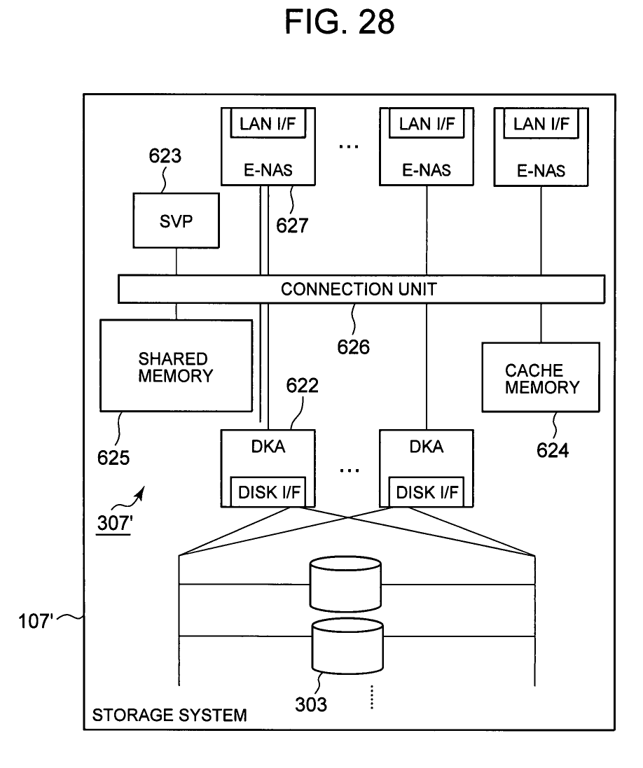

FIG. 28 illustrates an example of the structure of a storage system in a second embodiment of the present invention.

A storage system 107′ can be constituted by a disk array device equipped with a controller 307′ and a plurality of disk devices 303.

The controller 307′ comprises a plurality of channel adapter NASs 627 for providing service as an NAS (Network Attached Storage) (hereinafter referred to as E-NAS, for Embedded NAS), a plurality of disk adapters (DKA) 622, a service processor (SVP) 623, a cache memory 624, a shared memory 625, and a connection unit 626.

The E-NASs 627 can have the same functions as the nodes 109. The E-NASs 627 are constituted, for example, as a microcomputer system (such as a circuit board) equipped with a CPU, memory, etc., and are able to interpret and execute various commands received from the host 101. The E-NASs 627 receive file level I/O commands (such as commands including file names and instructions to read or write files having those file names; hereinafter referred to as “file I/O commands”) from the host 101, convert these file I/O commands into block level I/O commands, and send the product to the DKAs 622.

The DKAs 622 can be constituted as a microcomputer system (such as a circuit board) equipped with a CPU, memory, etc. The DKAs 622 receive block level I/O commands from the E-NASs 627, and use the I/O commands to access LDEVs on the plurality of disk devices 303.

The SVP 623 may, for example, be a device equipped with an input/output console and a control console (such as a personal computer), or the input/output console may be the management console 103, and a control console (such as what is called a mother board) may be connected to the management console 103. The SVP 623 controls the E-NASs 627 and the DKAs 622 by sending various commands to the E-NASs 627 and the DKAs 622. Also, the SVP 623 can monitor for the occurrence of a malfunction in the storage system 107′ and display [the result] on a console (such as a display device 175 provided to the management console 103), or give instructions to close off a disk device on the basis of a command from a console.

The cache memory 624 is used to temporarily store data received from the host 101, or data read out from an LDEV. The shared memory 625 is shared by the plurality of E-NASs 627 and the plurality of DKAs 622. Of the plurality of kinds of table discussed above, various tables whose contents are the same as those of all the E-NASs 627 (nodes 109), namely, the LDEV management table 429, the directory management table 431, and the file management table 433, may be recorded to the shared memory 625. The file data management table 435 and the LDEV free block bitmap 437 corresponding to the LDEVs being managed in the E-NASs 627 may also be stored in the memories of these E-NASs 627. Naturally, the table 435 and the bitmap 437 may also be stored in the shared memory 625, and conversely, the tables 429, 431, and 433 may be stored in the memories of the E-NASs 627. Also, the cache memory 624 and the shared memory 625 do not necessarily need to be physically separate memories.

The connection unit 626 connects the E-NASs 627, the DKAs 622, the cache memory 624, and the shared memory 625 to each other. The connection unit 626 can be constituted, for example, as a high-speed bus such as a super-high-speed crossbar switch that performs data transfer by high-speed switching.

### Third Embodiment

In a third embodiment, when protection is excessive compared to the required protect point of the protection object, the degree to which protection is excessive can be lowered, and the storage capacity taken up can thus be reduced, by executing migration of the protection object, or deletion of the protection object.

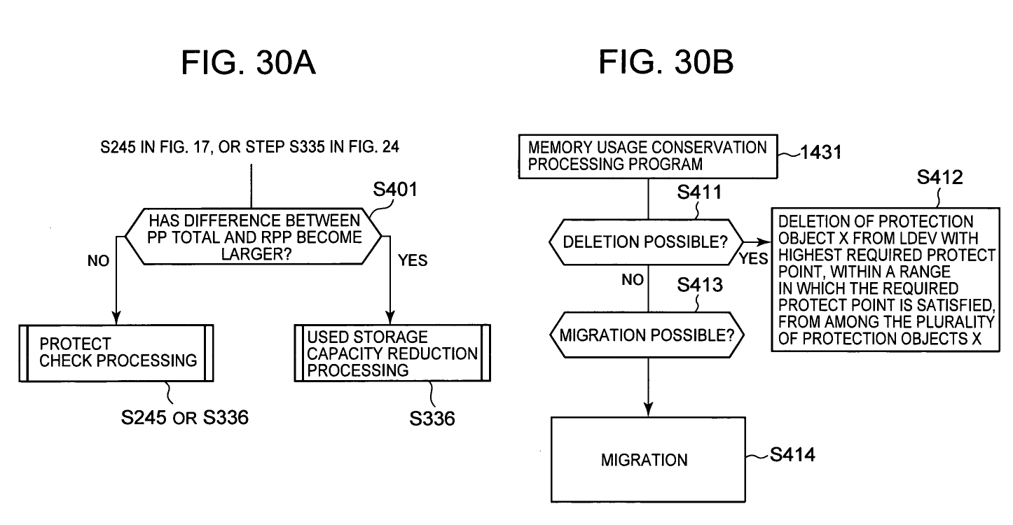

For example, in protect point update processing or in required protect point update processing, as shown in FIG. 30A, it is determined whether or not the difference between the protect point total (PP total) of the one or more LDEVs storing a protection object X and the required protect point of the protection object X became larger after step 245 in FIG. 17, or after step 335 in FIG. 24. For instance, this difference becomes larger if the protect point is lowered, or if the required protect point is raised. If it is not determined that the difference has become larger, protect check processing is executed, but if it is determined that the difference has become larger, memory usage conservation processing is executed. As shown in FIG. 30B, for example, memory usage conservation processing is executed by a memory usage conservation processing program 1431. This program 1431 is stored in the storage resource 277 of a node 109 and executed by the CPU 273 of the node 109, for example.

The memory usage conservation processing program 1431 uses an LDEV management table 428, the file management table 433, or the like to determine whether or not the deletion of the protection object X is possible (step 411). More specifically, for example, it is determined whether or not it is possible to maintain protection that satisfies the required protect point of the protection object X even if one or more of the protection objects X have been deleted from among the plurality of LDEVs storing the plurality of protection objects X. If this is deemed possible, the flow proceeds to step 412, but if it is deemed impossible, the flow proceeds to step 413.

In step 412, the memory usage conservation processing program 1431 deletes a protection object X from an LDEV corresponding to a protect point within a range in which the protect point total does not satisfy the required protect point, from among the plurality of LDEVs (such as an LDEV with the highest protect point in this range). This reduces the storage capacity used for the protection object X.

In step 413, the memory usage conservation processing program 1431 determines whether or not migration of the protection object X is possible. More specifically, for example, it is determined whether or not there is an LDEV Y that meets the following conditions (1) to (3):

(1) has free storage space equal to or greater than the size of the protection object X,

(2) is associated with a protect point lower than an LDEV X in which the protection object X is stored, and

(3) the protect point total is still equal to or greater than the required protect point of the protection object X even at the migration destination of the protection object A from the LDEV X.

If there is such an LDEV Y, the memory usage conservation processing program 1431 causes the protection object X to migrate from the LDEV X to the LDEV Y that meets the above-mentioned conditions (1) to (3). This reduces the amount of storage capacity used for the LDEV X with its high protect point.

### Fourth Embodiment

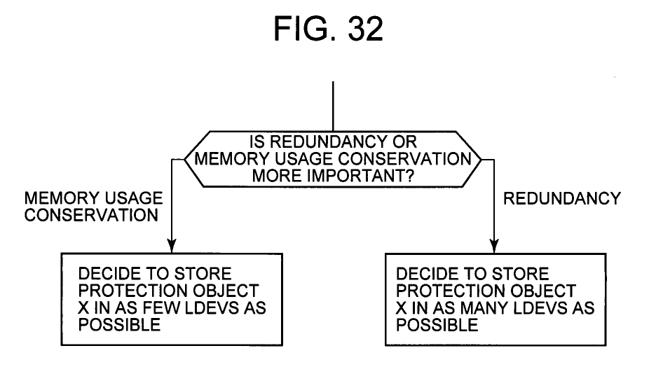

In a fourth embodiment, as shown in FIG. 32, the storage control of the protection object can be changed depending on whether redundancy or memory usage conservation is considered more important. This storage control can be executed, for example, in host write processing or protect check processing.

If redundancy is considered more important, for instance, the protection object X is stored in as many LDEVs as possible. More specifically, for example, even with an LDEV X associated with a protect point greater than or equal to the required protect point of the protection object X, the host write processing program 401 or the protect check processing program 411 uses as the write destination for the protection object X not this LDEV X, but a plurality of LDEVs whose protect point is lower than that of this LDEV X (in this case, of course, the write destination is one in which the protect point total is greater than or equal to the required protect point). As a result, even if there should be a malfunction in an LDEV in which the protection object X is stored, and the protection object X should disappear from that LDEV, the protection object X will still remain in as many LDEVs as possible.

On the other hand, if memory usage conservation is considered more important, the protection object X is stored in as few LDEVs as possible. More specifically, for example, if there is one LDEV X associated with a protect point greater than or equal to the required protect point of the protection object X, the host write processing program 401 or the protect check processing program 411 uses as the write destination for the protection object X a plurality of LDEVs whose protect point is lower than that of this LDEV X, so that the protection object X is written to the LDEV X even though storage control could be performed in which the protect point total is greater than or equal to the required protect point. This reduces the amount of capacity used for the protection object X. Furthermore, if memory usage conservation is considered more important, the memory usage conservation processing described for the third embodiment above, for example, may be executed.

Which of redundancy and memory usage conservation is more important may be determined from a policy set ahead of time by a manager, or may be decided by a computer program (such as the host write processing program 401 or the protect check processing program 411) on the basis of an attribute of the protection object.

Several preferred embodiments of the present invention were described above, but these are merely examples used to describe the present invention, and the scope of the present invention should not be construed to be limited to these embodiments. The present invention can be worked in various other configurations.

For example, in the above embodiments, a manager can decide on two or more LDEVs included in an exclusion protect group, but the configuration may instead be such that two or more LDEVs included in an exclusion protect group are decided on automatically. For instance, two or more LDEVs belonging to the same RAID group may be automatically considered to be two or more LDEVs belonging to an exclusion protect group.

Also, for example, instead of the completion of copying in protect check processing happening when data has been stored in the copy destination LDEV, it may happen when the node 109 that stores the data has stored it in the copy destination LDEV. More specifically, for example, when a node A manages an LDEV A, a node B manages an LDEV B, and the data to be copied from the LDEV A (block data constituting the protection object to be copied) is copied to the LDEV B, the node A reads the data to be copied from the LDEV A, and transfers the data it has read to the node B, the node B temporarily stores the data to be copied from the node A in the storage resource 277, and the temporarily stored data to be copied is written to the LDEV B. In this series of copying, the point when the data to be copied is written to the LDEV B may be considered the completion of the copying, or the point when the data to be copied has been temporarily stored in the node B may be considered the completion of the copying.

What is claimed is:

1. A storage control device, comprising:
a storage resource that stores storage device management information, which is information that includes a plurality of different protection capability values respectively associated with a plurality of storage devices having different protection capabilities; and
a protection controller that uses the storage device management information stored in the storage resource to store an electronic protection object in one or more of the plurality of storage devices so as to satisfy a required protection capability value, which is the protection capability required by the protection object.

2. The storage control device according to claim 1, wherein the one or more storage devices correspond to one or more protection capability values whose total is equal to or greater than the required protection capability value of the protection object.

3. The storage control device according to claim 1, further comprising a protection capability value setting unit that receives a designation of a storage device and a designation of a protection capability value associated with the storage device from an external console, which is a console outside of the storage control device, and includes a protection capability value associated with the storage device designated by the external console in the storage device management information.

4. The storage control device according to claim 1, further comprising a required protection capability value setting unit that receives a designation of a protection object stored in at least one of the plurality of storage devices and a designation of the required protection capability value associated with the protection object from an external console, which is a console outside of the storage control device, and associates the designated required protection capability value with the protection object designated by the external console.

5. The storage control device according to claim 1, wherein the protection controller determines whether or not there is a protection object whose required protection capability value has not been satisfied when either the required protection capability value of the protection object or the protection capability value of the storage device has been updated, and if a protection object whose required protection capability value has not been satisfied is detected, then the protection controller copies the protection object to another of the plurality of storage devices so as to satisfy the protection capability value required by the protection object.

6. The storage control device according to claim 5, wherein the update refers to a case in which the protection capability value of the storage device is set to zero.

7. The storage control device according to claim 6, wherein when copying is completed for all of the protection objects whose required protection capability values have not been satisfied, the protection controller sends information indicating the completion of copying to an external console, which is a console outside of the storage control device.

8. The storage control device according to claim 5, wherein the storage device management information includes an information element that expresses which two or more of the plurality of storage devices constitute an exclusion group, and
the protection controller selects, as a copy destination for the protection object whose required protection capability value has not been satisfied, another storage device different from the storage devices in the exclusion group including the storage device storing the protection object, and copies the protection object to the other storage device thus selected.

9. The storage control device according to claim 8, further comprising an exclusion group production unit that receives a designation of two or more of the plurality of storage devices and an exclusion group production designation from an external console, which is a console outside of the storage control device, and includes, in the storage device management information, an information element that expresses the exclusion group constituted by the two or more designated storage devices, according to the group production designation from the external console.

10. The storage control device according to claim 8, wherein each of the plurality of storage devices is a logical storage device provided on the basis of one or more physical storage devices,
the exclusion group is a group constituted by a plurality of logical storage devices within a storage system equipped with a plurality of physical storage devices, or a group constituted by a plurality of logical storage devices provided by a RAID group, and
the RAID group is a group constituted by RAIDs, by means of two or more of the plurality of physical storage devices.

11. The storage control device according to claim 1, wherein the protection object is a file and/or a directory, and
the required protection capability value is associated with a file, a directory, or a group unit thereof.

12. The storage control device according to claim 11, wherein, when the protection controller receives a file sent from a host device and no required protection capability value is associated with the file, the protection controller associates the required protection capability value of the directory of the write destination, with the file.

13. The storage control device according to claim 1, wherein, in a first case, the protection controller stores the same protection object in plural storage devices, and in a second case, stores the same protection object in fewer storage devices than in the first case.

14. The storage control device according to claim 13, wherein the first case is when redundancy has greater importance than memory usage conservation, and the second case is when memory usage conservation has greater importance than redundancy.

15. The storage control device according to claim 1, wherein, when either the required protection capability value of the protection object or the protection capability value of the storage device has been updated, the protection controller deletes the protection object from at least one of the two or more storage devices in which the protection object is stored in a case where storage that satisfies the required protection capability value of the protection object can be maintained even if the protection object is deleted from the at least one storage device.

16. The storage control device according to claim 1, wherein the storage control device is a storage system equipped with a plurality of nodes, or a plurality of nodes and a plurality of storage devices.

17. The storage control device according to claim 1, wherein the storage device management information includes an information element that expresses which two or more of the plurality of storage devices constitute an exclusion group, and
the protection controller
receives a protection object sent from a host device and writes the protection object to two or more storage devices that do not cover the exclusion group and correspond to the two or more protection capability values whose total is equal to or greater than the required protection capability value of the protection object, and
determines whether or not there is a protection object whose required protection capability value has not been satisfied when either the required protection capability value of the protection object or the protection capability value of the storage device has been updated, and if a protection object whose required protection capability value has not been satisfied is detected, then the protection controller copies the protection object to another of the plurality of storage devices, which does not cover the exclusion group, and is different from the storage device in which the protection object is stored, so as to satisfy the protection capability value required by the protection object.

18. A storage control method, comprising the steps of:
identifying, from storage device management information which is information that includes a plurality of different protection capability values respectively associated with a plurality of storage devices having different protection capabilities, the respective protection capability values for the respective storage devices, and
filing an electronic protection object in one or more of the plurality of storage devices so as to satisfy a required protection capability value, which is the protection capability required by the protection object.

19. The storage control method according to claim 18, further comprising: a step of updating either the required protection capability value of the protection object or the protection capability value of the storage device; a step of determining whether or not there is a protection object whose required protection capability value has not been satisfied; and a step of, if a protection object whose required protection capability value has not been satisfied is detected, copying the protection object to another of the plurality of storage devices so as to satisfy the protection capability value required by the protection object.

20. The storage control method according to claim 19, further comprising a step of, in the update of either the required protection capability value of the protection object or the protection capability value of the storage device, updating the protection capability value of the storage device to be replaced to zero.
